(19) United States
(12) Patent Application Publication
(10) Pub. No.: US 2023/0342981 A1
(43) Pub. Date: Oct. 26, 2023

(54) INFORMATION PROCESSING DEVICE AND METHOD

(71) Applicant: Sony Group Corporation, Tokyo (JP)

(72) Inventors: Satoru KUMA, Tokyo (JP); Ohji NAKAGAMI, Tokyo (JP)

(73) Assignee: Sony Group Corporation, Tokyo (JP)

(21) Appl. No.: 18/026,713

(22) PCT Filed: Sep. 24, 2021
(86) PCT No.: PCT/JP2021/034951

§ 371 Date: Mar. 16, 2023

(30) Foreign Application Priority Data
Oct. 6, 2020 (JP) 2020-169143

(51) Int. Cl. G06T 9/00; G06T 17/00; G06T 7/60

(52) U.S. Cl. CPC G06T 9/001; G06T 17/00; G06T 7/60

(57) ABSTRACT

There is provided an information processing device and method capable of suppressing an increase in a load of processing for decoding point cloud data. Slice correspondence information that is information indicating a slice of geometry data corresponding to a resolution and a region of a geometry is generated for a point cloud representing an object having a three-dimensional shape as a set of points, and the geometry data and the generated slice correspondence information are encoded so that a bitstream of the geometry is generated. The present disclosure can be applied to, for example, an information processing device, an encoding device, a decoding device, an electronic device, an information processing method, or a program.

### TECHNICAL FIELD

The present disclosure relates to an information processing device and method, and more particularly, to an information processing device and method capable of suppressing an increase in a load of processing for decoding point cloud data.

### BACKGROUND ART

In the related art, a method of encoding 3D data representing a three-dimensional structure such as a point cloud has been considered (see, for example, NPL 1). Further, a method of realizing parallel decoding or the like by signaling a flag for dividing an Octree of a point cloud into node groups has been considered (see, for example, NPL 2).

### CITATION LIST

### Non Patent Literature

[NPL 1]
R. Mekuria, Student Member IEEE, K. Blom, P. Cesar, Member, IEEE, “Design, Implementation and Evaluation of a Point Cloud Codec for Tele-Immersive Video”, tcsvt_paper_submitted_february.pdf
[NPL 2]
David Flynn, Khaled Mammou, “G-PCC: A hierarchical geometry slice structure”, ISO/IEC JCTC1/SC29/WG11 MPEG/m54677, April 2020, Online

### SUMMARY

### Technical Problem

However, in the method described in NPL 2, information of each node group is stored in, for example, a header of each node group, it is necessary to parse the entire bitstream in order to obtain information required when scalability of a region or resolution is realized, and there is concern of a load of decoding processing increasing.

The present disclosure has been made in view of such circumstances, and is intended to enable an increase in a load of processing for decoding point cloud data to be suppressed.

### Solution to Problem

An information processing device according to an aspect of the present technology is an information processing device including: a slice correspondence information generation unit configured to generate slice correspondence information, the slice correspondence information being information indicating a slice of geometry data corresponding to a resolution and a region of a geometry, for a point cloud representing an object having a three-dimensional shape as a set of points; and an encoding unit configured to encode the geometry data to generate a bitstream of the geometry including the slice correspondence information generated by the slice correspondence information generation unit.

An information processing method according to an aspect of the present technology is an information processing method including: generating slice correspondence information, the slice correspondence information being information indicating a slice of geometry data corresponding to a resolution and a region of a geometry, for a point cloud representing an object having a three-dimensional shape as a set of points; and encoding the geometry data to generate a bitstream of the geometry including the generated slice correspondence information.

An information processing device according to another aspect of the present technology is an information processing device including: a decoding target selection unit configured to select, as a decoding target, a slice of geometry data corresponding to a resolution and a region of a geometry as a decoding target from a bitstream of the geometry, on the basis of slice correspondence information, the slice correspondence information being information indicating the slice of the geometry data corresponding to the resolution and the region of the geometry, for a point cloud representing an object having a three-dimensional shape as a set of points; and a decoding unit configured to decode the slice selected by the decoding target selection unit.

An information processing method according to another aspect of the present technology is an information processing method including: selecting, as a decoding target, a slice of geometry data corresponding to a resolution and a region of a geometry as a decoding target from a bitstream of the geometry, on the basis of slice correspondence information, the slice correspondence information being information indicating the slice of the geometry data corresponding to the resolution and the region of the geometry, for a point cloud representing an object having a three-dimensional shape as a set of points; and decoding the selected slice.

In the information processing device and method according to the aspect of the present technology, the slice correspondence information that is information indicating the slice of the geometry data corresponding to the resolution and the region of the geometry is generated for the point cloud representing an object having a three-dimensional shape as a set of points, and the geometry data is encoded to generate the bitstream of the geometry including the generated slice correspondence information.

In the information processing device and method according to the other aspect of the present technology, the slice of the geometry data corresponding to the resolution and the region of the geometry as the decoding target is selected as a decoding target from the bitstream of the geometry, on the basis of the slice correspondence information that is information indicating the slice of the geometry data corresponding to the resolution and the region of the geometry, for the point cloud representing an object having a three-dimensional shape as a set of points, and the selected slice is decoded.

### BRIEF DESCRIPTION OF DRAWINGS

FIG. 1 is a diagram illustrating examples of a tree structure and a slice structure.

FIG. 2 is a diagram illustrating an example of slice correspondence information.

FIG. 3 is diagram illustrating examples of a tree structure and a slice structure.

FIG. 4 is a diagram illustrating an example of slice correspondence information.

FIG. 5 is a diagram illustrating examples of a tree structure and a slice structure.

FIG. 6 is a diagram illustrating an example of slice correspondence information.

FIG. 7 is a diagram illustrating an example of attribute correspondence information.

FIG. 8 is a diagram illustrating an example of attribute correspondence information.

FIG. 9 is a diagram illustrating an example of attribute correspondence information.

FIG. 10 is a diagram illustrating an example of slice address information.

FIG. 11 is a diagram illustrating an example of parallelization information.

FIG. 12 is a block diagram illustrating a main configuration example of an encoding device.

FIG. 13 is a flowchart illustrating an example of a flow of encoding processing.

FIG. 14 is a block diagram illustrating a main configuration example of an encoding device.

FIG. 15 is a flowchart illustrating an example of a flow of decoding processing.

FIG. 16 is a flowchart illustrating an example of a flow of decoding target selection processing.

FIG. 17 is a flowchart illustrating an example of a flow of decoding target decoding processing.

FIG. 18 is a block diagram illustrating a main configuration example of a computer.

### DESCRIPTION OF EMBODIMENTS

Hereinafter, a form for carrying out the present disclosure (hereinafter referred to as an embodiment) will be described. The description will be given in the following order.
1. Signaling of Slice Correspondence Information
2. First Embodiment (encoding device)
3. Second Embodiment (decoding device)
4. Supplements

### 1. Signaling of Slice Correspondence Information

<Literature or Like Supporting Technical Content and Technical Terms>

The scope disclosed in the present technology includes not only the content described in the embodiments, but also the content described in the following NPL known at the time of filing.
NPL 1: (described above)
NPL 2: (described above)

That is, content described in the above-described NPL, content of other literature referred to in the above-described NPL, and the like are also the basis for determining the support requirements.

<Point Cloud>

In the related art, as 3D data, there has been a point cloud that represents a three-dimensional structure (an object having a three-dimensional shape) as a set of many points. Data of a point cloud (also referred to as point cloud data) includes position information (also referred to as a geometry) and attribute information (also referred to as an attribute) of each point. The attributes may include arbitrary information. For example, the attributes may include color information, reflectance information, normal information, and the like for each point. Thus, the point cloud has a relatively simple data structure and can represent any three-dimensional structure with sufficient accuracy by using a sufficiently large number of points.

The point cloud data has a relatively large amount of data. Further, the amount of data increases in proportion to an increase in the number of points. This increases a load when the point cloud data is transmitted or stored, for example. Therefore, in order to reduce the amount of data, voxel conversion is considered. A voxel is a three-dimensional region for quantizing a geometry (positional information).

That is, the three-dimensional region (also called a bounding box) containing the point cloud is divided into small three-dimensional regions called voxels, and whether or not each voxel contains a point is indicated. By doing this, the position of each point is quantized in units of voxels. Therefore, an increase in amount of information can be suppressed (typically, the amount of information can be reduced).

The resolution of the geometry (that is, the number of points) depends on a size of the voxel (in other words, the number of voxels). When the voxel size is smaller (there are more voxels), the number of points increases, and thus the resolution of the geometry becomes higher.

It is conceivable to divide the voxel recursively using such characteristics and convert the geometry into a tree structure. Such a method enables the resolution of the geometry to be variable. That is, the geometry can be represented not only at the highest resolution corresponding to a bottom layer of the tree structure, but also at a low resolution corresponding to an intermediate layer of the tree structure.

Further, a method of encoding or decoding point cloud data has been considered in order to suppress an increase in load when point cloud data is transmitted or stored. For example, when the point cloud data is transmitted, a transmission side encodes the point cloud data to generate a bitstream and transmits the bitstream, and a reception side decodes the bitstream to generate the point cloud data. By doing this, it is possible to reduce a data amount at the time of transmission, and to suppress an increase in load. The same applies to a case in which point cloud data is stored.

As described above, the point cloud includes the geometry and the attribute. That is, each piece of data of the geometry and the attribute is encoded or decoded.

It is possible to decode encoded data of the geometry in a scalable manner with respect to the resolution by encoding data of the geometry (also referred to as geometry data) according to the tree structure described above. That is, it is possible to realize resolution scalability in the decoding process. For example, it becomes possible to realize partial decoding such as decoding only nodes from a top layer to an arbitrary layer of the tree structure (not decoding the nodes in lower layers). That is, it is possible to obtain the geometry having desired resolution by decoding only a necessary part without decoding all encoded data of the geometry.

<Node Grouping>

Incidentally, NPL 2 discloses a method of signaling a flag for dividing a tree structure (Octree) of this point cloud into node groups. This method enables independent decoding for each node group. Therefore, for example, the decoding processing can be divided for each node group and parallelized. It is also possible to decode only some node groups. For example, it is possible to decode only a geometry of a partial region by dividing the node group into partial regions of a three-dimensional region. That is, in the decoding processing, it is possible to realize scalability for the region. That is, it is possible to obtain a geometry of a desired region by decoding only a necessary part without decoding all encoded data of the geometry.

However, in the method described in NPL 2, the information of each node group is stored in, for example, the header of each node group. For example, information indicating a node group required to be decoded before such a node group is decoded (more specifically, information indicating a correspondence relationship between points) is stored in the header of each node group. In order to realize scalability of the region or resolution at the time of decoding, it is necessary to collect this information, specify a node group to be decoded, and specify a decoding order thereof. However, since this information is stored in each node group as described above, it is necessary to parse the entire bitstream in order to obtain required information. Therefore, there is concern of a load of decoding processing increasing.

<Signaling of Slice Correspondence Information>

Therefore, slices (node groups) are set in geometry data having a tree structure, and slice correspondence information, which is information indicating a correspondence relationship between the resolution and region of the geometry and the slices, is signaled (transmitted). For example, this slice correspondence information is signaled at the time of encoding the geometry. Further, this slice correspondence information is referred to when the encoded data of the geometry is decoded.

The tree structure of the geometry may be any tree structure. For example, the tree structure of the geometry may be an Octree or a KD Tree, or the tree structure of the geometry may be another structure. The slice is a grouping of nodes in the tree structure of the geometry. The geometry data is encoded or decoded independently for each slice. That is, the geometry data can be encoded or decoded in units of slices.

In the slice correspondence information, a slice (node group) corresponding to the resolution (layers of the tree structure) and a region (partial region of a three-dimensional region) are shown for such a tree-structured geometry. That is, the slice to which the node group having the resolution located in the region belongs is shown. In other words, in the slice correspondence information, resolution and a region corresponding to each slice, that is, resolution of the node group belonging to the slice and a region in which the node group exists are shown. Therefore, it is possible to specify slices to be decoded in order to obtain nodes of desired resolution and region by referring to this slice correspondence information at the time of decoding. That is, when this slice correspondence information is signaled at the time of encoding the geometry data, it is not necessary to parse the entire geometry data at the time of decoding, and it is possible to suppress an increase in the load of the decoding processing (typically, to reduce the load). Further, when processing is performed on the basis of this signaled slice correspondence information at the time of decoding the geometry data, it is not necessary to parse the entire geometry data, and it is possible to suppress an increase in the load of the decoding processing (typically, to reduce the load).

<Slice ID>

A format of the slice correspondence information is arbitrary. For example, the slice corresponding to the resolution and the region may be indicated using identification information (slice ID). The identification information (slice ID) of the slice may be of any format. For example, different numbers or characters assigned to respective slices may be used. The slice can be easily specified by using the identification information. Further, the slice corresponding to the resolution and the region may be indicated by something other than the identification information, such as an address in the geometry data.

<Signaling of Decoding Order Information>

Further, decoding order information, which is information on a decoding order of slices corresponding to the resolution and the region, may be signaled. For example, nodes in an upper layer to which the node belongs directly or indirectly are required to obtain nodes in a certain layer in the tree structure. That is, in order to decode the bitstream and generate the nodes of the desired resolution and region, it is necessary to decode not only slices corresponding to the resolution and region, but also slices corresponding to upper layers. These slice groups are indicated in the decoding order information. Therefore, it is possible to easily specify a slice group to be decoded in order to generate the nodes of the desired resolution and region on the basis of this decoding order information.

Further, the decoding information also indicates in what order the slice group is to be decoded. Therefore, it is possible to efficiently perform decoding by decoding each slice in the decoding order indicated by the decoding order information.

Additionally, it is possible to obtain this information without parsing the entire geometry data by referring to such decoding order information. That is, it is possible to suppress an increase in the load of the decoding processing (typically, to reduce the load) by signaling this decoding order information at the time of encoding the geometry data. Further, it is possible to suppress an increase in the load of decoding processing (typically, to reduce the load) by performing processing on the basis of this signaled decoding order information at the time of decoding the geometry data.

<Signaling of Slice Inside Information>

Further, slice inside information, which is information on the inside of the slice, may be signaled. The slice inside information includes information on the inside of the slice that can be used at the time of decoding. Therefore, it is possible to efficiently perform decoding by decoding the slice on the basis of this slice inside information. That is, it is possible to perform the decoding processing more efficiently by signaling this slice inside information at the time of encoding of the geometry data. Further, when a plurality of slices are decoded in decoding the geometry data, it is possible to perform the decoding more efficiently by parallelizing the decoding processing on the basis of the slice inside information of each slice.

<Number of Points>

For example, the slice inside information may include number-of-points information, which is information indicating the number of points in the slice. As described above, an amount of data of the geometry depends on the number of points. In other words, the load of the decoding processing depends on the number of points. For example, as the number of points in the slice increases, a load of decoding processing for the slice increases. That is, it is possible to predict a magnitude of the load of the decoding processing for each slice on the basis of this number-of-points information. Therefore, it is possible to perform the decoding processing more efficiently by performing the decoding processing on the basis of this number-of-points information. For example, it is possible parallelize the decoding processing so that an amount of load of each processing is more averaged, on the basis of the number-of-points information. It is also possible to distribute the amount of load according to hardware constraints.

### Slice Correspondence Information Example 1

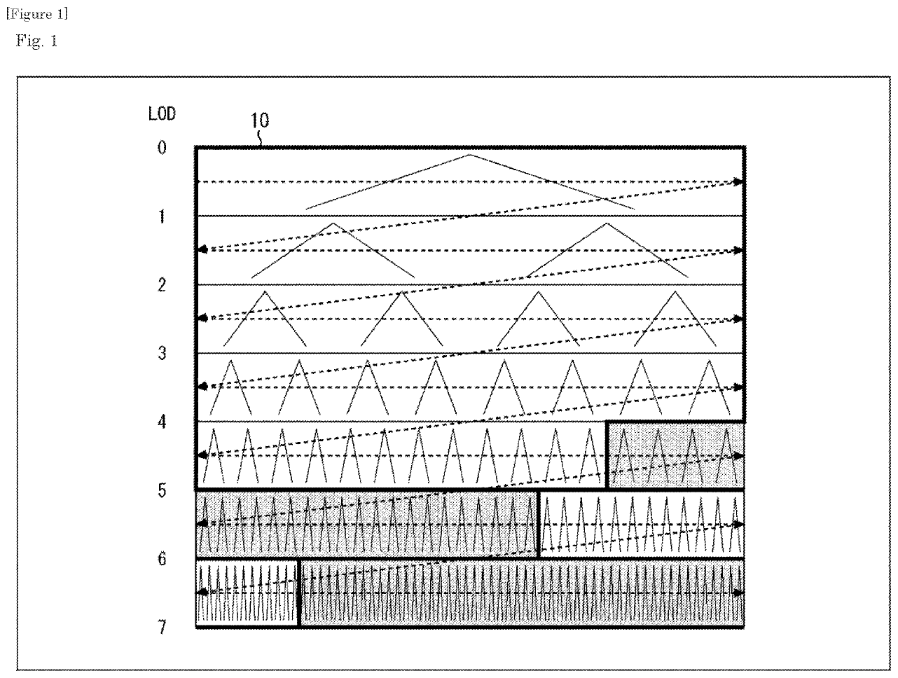

For example, geometry data 10 illustrated in FIG. 1 has a tree structure from LoD 0 to LoD 7. LoD indicates a layer of the tree structure. Each node of this tree structure is encoded or decoded for each layer in order from LoD 0 to LoD 7 (in order from an upper layer to a lower layer), as indicated by a dashed arrow.

It is assumed that slices are set for such geometry data 10 as illustrated in FIG. 1. In FIG. 1, a node group surrounded by a thick line forms one slice. For example, all the nodes of LoD 0 to LoD 4 and the nodes of region 1 (a white region) of LoD 5 belong to slice 1. The nodes in region 2 (a gray region) of LoD 5 and region 3 (a gray region) of LoD 6 belong to slice 2. Nodes in region 4 (a white region) of LoD 6 and region 5 (a white region) of LoD 7 belong to slice 3. The nodes in region 6 (a gray region) of LoD 7 belong to slice 4.

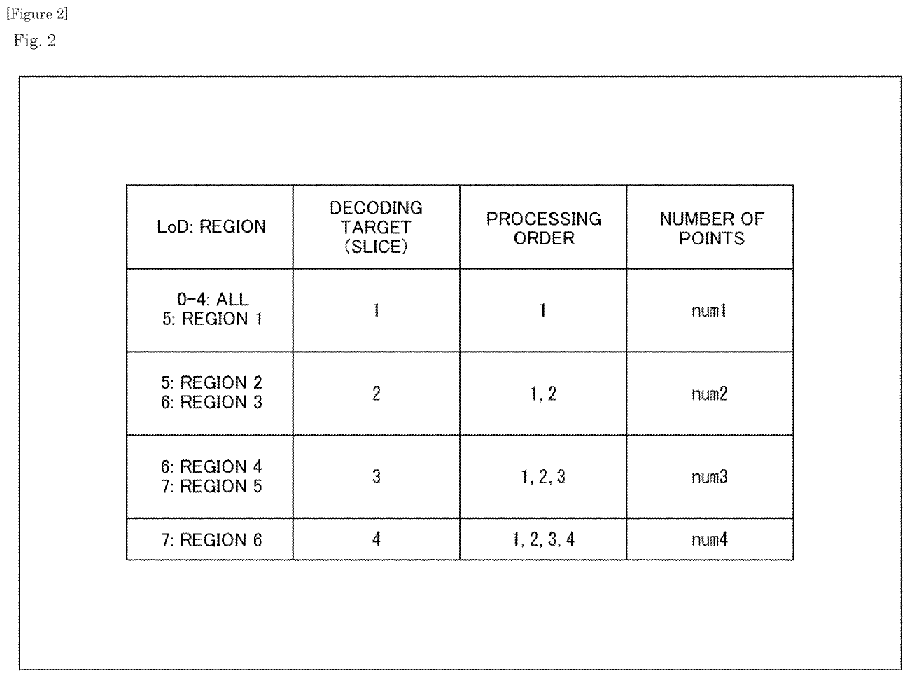

An example of the slice correspondence information signaled for the geometry data 10 having such a slice structure, for example, is illustrated in FIG. 2. In a table illustrated in FIG. 2, slices corresponding to each layer and each region (a column of “LoD: region”) (column “decoding target (slice)”) are shown as the slice correspondence information. For example, a second row from the top of the table illustrated in FIG. 2 shows that, when a bitstream of the geometry is decoded, slice 1 is set as a decoding target in order to obtain the nodes of entire LoD 0 to LoD 4 and region 1 of LoD 5. A third row from the top shows that slice 2 is set as a decoding target in order to obtain the nodes in region 2 of LoD 5 and region 3 of LoD 6. Further, a fourth row from the top shows that slice 3 is set as a decoding target in order to obtain the nodes in region 4 of LoD 6 and region 5 of LoD 7. Further, a fifth row from the top shows that slice 4 is set as a decoding target in order to obtain nodes in region 6 of LoD 7.

By signaling such slice correspondence information at the time encoding the geometry data, it is not necessary to parse the entire geometry data at the time of decoding, and it is possible to suppress an increase in the load of the decoding processing (typically, to reduce the load). Further, by performing processing on the basis of this signaled slice correspondence information at the time of decoding the geometry data, it is not necessary to parse the entire geometry data, and it is possible to suppress an increase in the load of the decoding processing (typically, to reduce the load).

Further, a column “processing order” of the table illustrated in FIG. 2 shows the slice groups necessary to obtain the nodes of each resolution and region, and decoding order thereof as decoding order information. For example, a second row from the top of the table illustrated in FIG. 2 shows that only slice 1 needs to be decoded. Further, a third row from the top shows that slice 1 and slice 2 only need to be decoded in this order. Further, a fourth row from the top shows that slice 1, slice 2, and slice 3 only need to be decoded in this order. A fifth row from the top shows that slice 1, slice 2, slice 3, and slice 4 need to be decoded in this order.

It is possible to efficiently perform decoding by decoding the respective slices according to this processing order. For example, it is possible to generate and display a low resolution point cloud belonging to slice 1 before the decoding of slice 2 ends by decoding slice 1 before decoding slice 2. That is, it is possible to decode a high resolution slice while displaying a low resolution point cloud.

Further, a column “number of points” in the table illustrated in FIG. 2 shows the number of points (number-of-points information) in each slice as the slice inside information. For example, a second row from the top of the table illustrated in FIG. 2 shows that the number of points in slice 1 is num1. Further, a third row from the top shows that the number of points in slice 2 is num2. Further, a fourth row from the top shows that the number of points in slice 3 is num3. Further, a fifth row from the top shows that the number of points in slice 4 is num4. It is possible to efficiently perform decoding by decoding a slice on the basis of this slice inside information.

### Slice Correspondence Information Example 2

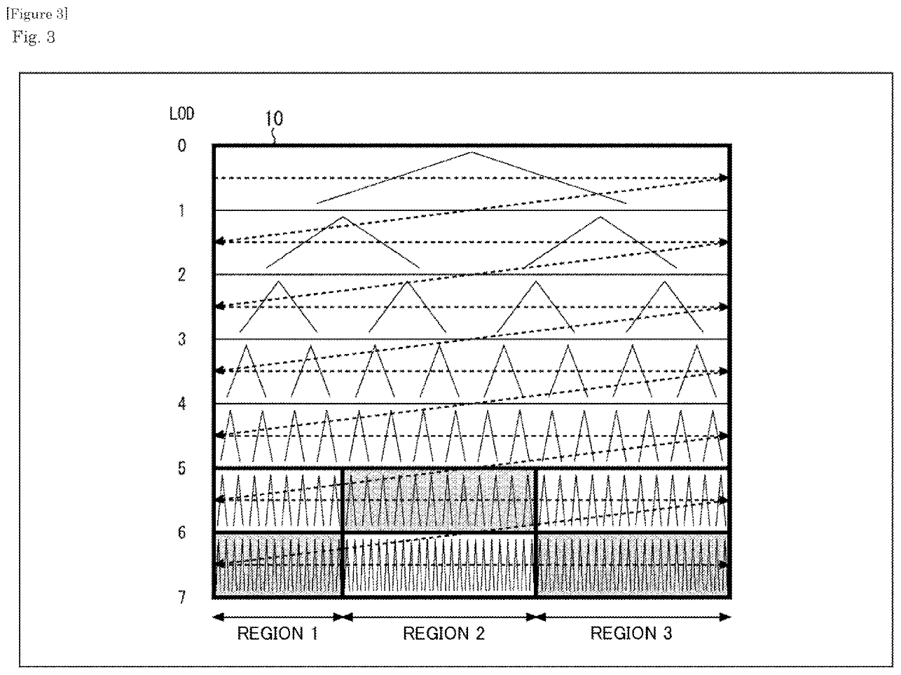

Another example of the slice structure set in the geometry data 10 is illustrated in FIG. 3. In the example of FIG. 3, all nodes LoD 0 to LoD 5 belong to slice 1. Nodes of LoD 6 and LoD 7 are divided and sliced into three regions, region 1, region 2, and region 3, respectively. That is, the nodes in region 1 (a white region) of LoD 6 belong to slice 2. The nodes in region 2 (a gray region) of LoD 6 belong to slice 3. The nodes in region 3 (a white region) of LoD 6 belong to slice 4. The nodes in region 1 (a gray region) of LoD 7 belong to slice 5. The nodes in region 2 (a white region) of LoD 7 belong to slice 6. The nodes in region 3 (a gray region) of LoD 7 belong to slice 7.

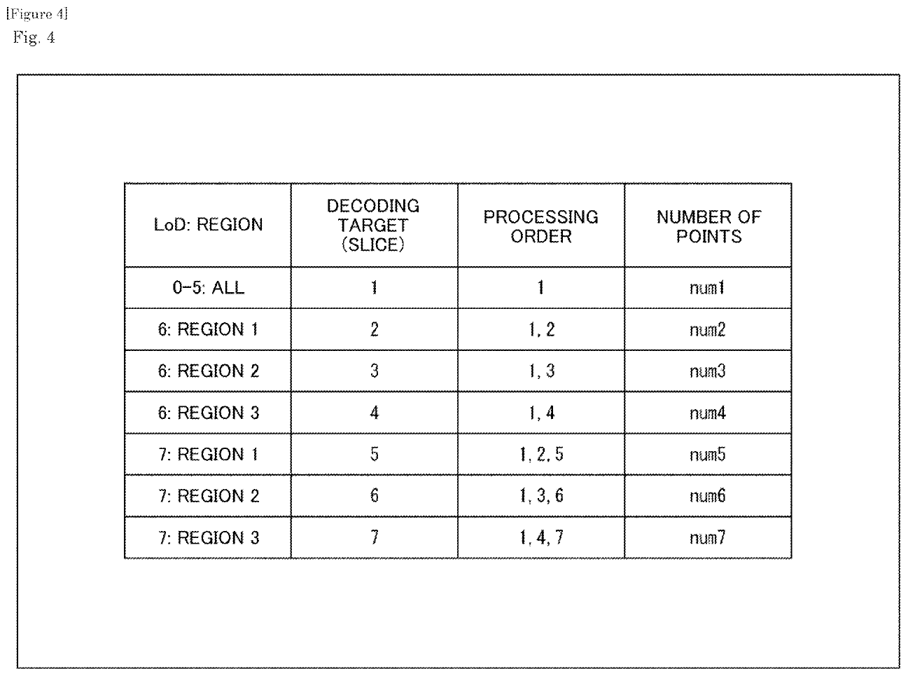

An example of the slice correspondence information signaled for the geometry data 10 having such a slice structure, for example, is illustrated in FIG. 4. In a table illustrated in FIG. 4, slice correspondence information (a column “decoding target (slice)”) corresponding to each layer and each region (column “LoD: region”) is shown, as in the case of FIG. 2. Further, decoding order information (a column “processing order”) is shown. Further, the slice inside information (a column “number of points”) is shown.

For example, a second row from the top of the table illustrated in FIG. 4 shows that all nodes LoD 0 to LoD 5 belong to slice 1. The second row also shows that only slice 1 needs to be decoded to generate points of LoD 0 to LoD 5. Further, the second row shows that the number of points in slice 1 is num1.

Further, a third row from the top of the table illustrated in FIG. 4 shows that the nodes in region 1 of LoD 6 belong to slice 2. The third row also shows that slice 1 and slice 2 need to be decoded in this order to generate points in region 1 of LoD 6. Further, the third row shows that the number of points in slice 2 is num2. Further, a fourth row from the top of the table illustrated in FIG. 4 shows that the nodes in region 2 of LoD 6 belong to slice 3. Further, the fourth row shows that slices 1 and 3 only need to be decoded in that order to generate points in region 2 of LoD 6. Further, the fourth row shows that the number of points in slice 3 is num3. Further, a fifth row from the top of the table illustrated in FIG. 4 shows that the nodes in region 3 of LoD 6 belong to slice 4. Further, fifth row shows that slices 1 and 4 only need to be decoded in that order to generate points in region 3 of LoD 6. Further, the fifth row shows that the number of points in slice 4 is num4.

Further, a sixth row from the top of the table illustrated in FIG. 4 shows that the nodes in region 1 of LoD 7 belong to slice 5. Further, the sixth row shows that slice 1, slice 2, and slice 5 need to be decoded in this order to generate points in region 1 of LoD 7. Further, the sixth row shows that the number of points in slice 5 is num5. Further, a seventh row from the top of the table illustrated in FIG. 4 shows that the nodes in region 2 of LoD 7 belong to slice 6. Further, the seventh row shows that slices 1, 3, and 6 need to be decoded in this order to generate points in region 2 of LoD 7. Further, the seventh row shows that the number of points in slice 6 is num6. Further, an eighth row from the top of the table illustrated in FIG. 4 shows that the nodes in region 3 of LoD 7 belong to slice 7. Further, the eighth row shows that slices 1, 4, and 7 only need to be decoded in that order to generate points in region 3 of LoD 7. Further, the eighth row shows that the number of points in slice 7 is num7.

By signaling such slice correspondence information at the time of encoding the geometry data, it is not necessary to parse the entire geometry data at the time of decoding, and it is possible to suppress an increase in the load of the decoding processing (typically, to reduce the load). Further, by performing processing of the geometry data on the basis of this signaled slice correspondence information at the time of decoding, it is not necessary to parse the entire geometry data, and it is possible to suppress an increase in the load of the decoding processing (typically, to reduce the load). Further, it is possible to efficiently perform decoding by decoding the respective slices according to this decoding order information. Further, it is possible to efficiently perform decoding by decoding the slices on the basis of this slice inside information.

### Slice Correspondence Information Example 3

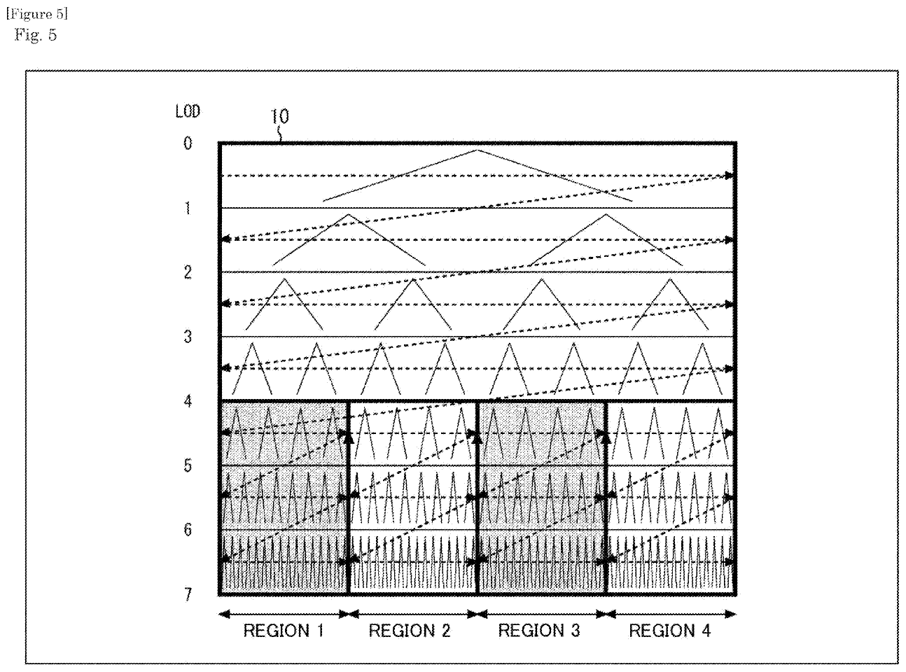

Another example of the slice structure set in the geometry data 10 is illustrated in FIG. 5. In the example of FIG. 5, each node of this tree structure is encoded or decoded for each layer in order from an upper layer to a lower layer for an entire region from LoD 0 to LoD 4, as indicated by a dashed arrows. LoD 5 to LoD 7 are encoded and decoded for each layer in order from the upper layer to the lower layer for each of the regions 1 to 4.

All the nodes of LoD 0 to LoD 4 belong to slice 1. The nodes in region 1 (a gray region) of LoD 5 to LoD 7 belong to slice 2. The nodes in region 2 (a white region) of LoD 5 to LoD 7 belong to slice 3. The nodes in region 3 (a gray region) of LoD 5 to LoD 7 belong to slice 4. The nodes in region 4 (a white region) of LoD 5 to LoD 7 belong to slice 5.

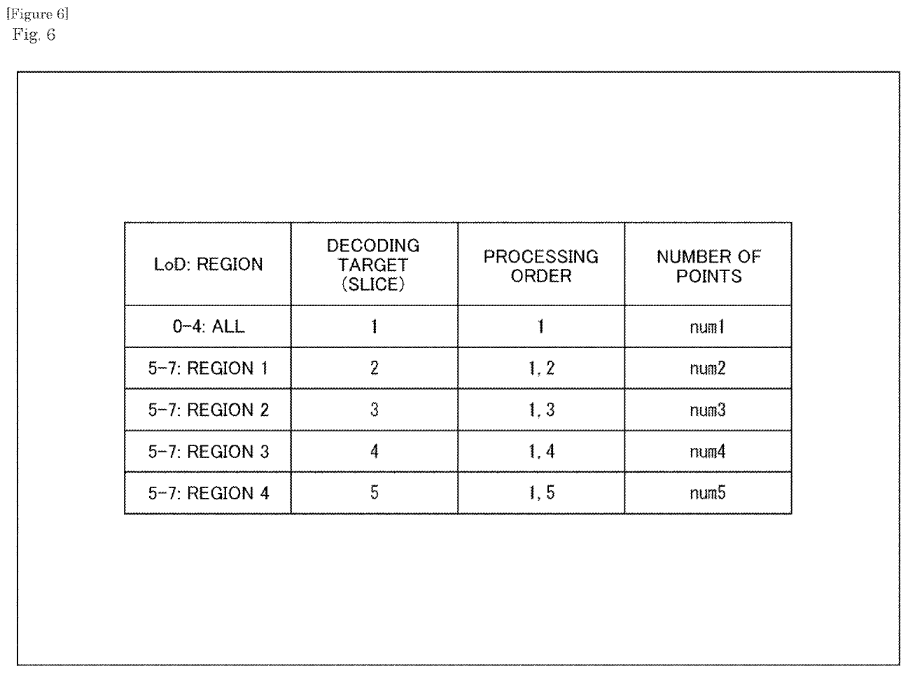

An example of slice correspondence information signaled for the geometry data 10 having such a slice structure, for example, is illustrated in FIG. 6. In a table illustrated in FIG. 6, slice correspondence information (a column “decoding target (slice)”) corresponding to each layer and each region (column “LoD: region”) is shown, as in the case of FIG. 2. Further, decoding order information (a column “processing order”) is shown. Further, the slice inside information (a column “number of points”) is shown.

For example, a second row from the top of the table illustrated in FIG. 6 shows that all nodes of LoD 0 through LoD 4 belong to slice 1. Further, the second row shows that only slice 1 needs to be decoded to generate points of LoD 0 to LoD 4. Further, the second row shows that the number of points in slice 1 is num1.

Further, a third row from the top of the table illustrated in FIG. 6 shows that the nodes in region 1 of LoD 5 to LoD 7 belong to slice 2. Further, the third row shows that slices 1 and 2 need to be decoded in this order to generate points in region 1 of LoD 5 to LoD 7. Further, the third row shows that the number of points in slice 2 is num2.

Further, a fourth row from the top of the table illustrated in FIG. 6 shows that the nodes in region 2 of LoD 5 to LoD 7 belong to slice 3. Further, the fourth row shows that slices 1 and 3 need to be decoded in this order to generate points in region 2 of LoD 5 to LoD 7. Further, the fourth row shows that the number of points in slice 3 is num3.

Further, a fifth row from the top of the table illustrated in FIG. 6 shows that the nodes in region 3 of LoD 5 to LoD 7 belong to slice 4. Further, the fifth row shows that slices 1 and 4 need to be decoded in this order to generate points in region 3 of LoD 5 to LoD 7. Further, the fifth row shows that the number of points in slice 4 is num4.

Further, a sixth row from the top of the table illustrated in FIG. 6 shows that the nodes in region 4 of LoD 5 to LoD 7 belong to slice 5. Further, the sixth row shows that slices 1 and 5 need to be decoded in this order to generate points in region 4 of LoD 5 to LoD 7. Further, the sixth row shows that the number of points in slice 5 is num5.

By signaling such slice correspondence information at the time of encoding the geometry data, it is not necessary to parse the entire geometry data at the time of decoding, and it is possible to suppress an increase in the load of the decoding processing (typically, to reduce the load). Further, by performing processing of the geometry data on the basis of this signaled slice correspondence information at the time of decoding, it is not necessary to parse the entire geometry data, and it is possible to suppress an increase in the load of the decoding processing (typically, to reduce the load). Further, it is possible to efficiently perform decoding by decoding the respective slices according to this decoding order information. Further, it is possible to efficiently perform decoding by decoding the slices on the basis of this slice inside information.

<Signaling of Attribute Correspondence Information>

Attribute correspondence information that is information indicating attribute data corresponding to the slice of the geometry (also referred to as attribute data) may be signaled. In order to decode the bitstream and generate a point cloud, it is necessary to decode not only the geometry, but also the attribute corresponding to the geometry. Information for obtaining the attribute corresponding to the geometry (that is, information for specifying the attribute data) is indicated for each slice in the attribute correspondence information. Therefore, it is possible to easily specify the attribute data corresponding to the slice that is a decoding target by referring to this attribute correspondence information.

That is, it is possible to suppress an increase in the load of the decoding processing (typically, to reduce the load) by signaling this attribute correspondence information at the time of encoding. Further, it is possible to suppress an increase in the load of the decoding processing (typically, to reduce the load) by performing processing on the basis of this signaled attribute correspondence information at the time of decoding.

<Bitstream ID of Attribute>

A format of the attribute correspondence information is arbitrary. For example, the attribute data corresponding to the slice may be indicated using identification information of the attribute data (for example, identification information of the bitstream of the attribute). The identification information (for example, a bitstream ID) of the attribute data may be of any format. For example, the identification information may be different numbers or letters assigned to each bitstream of the attribute. It is possible to easily specify the bitstream by using the identification information. Further, attribute data corresponding to the resolution and the region may be indicated by something other than the identification information, such as an address in the bitstream of the attribute.

### Attribute Correspondence Information Example 1

The attribute can be encoded, for example, not to support scalability (non-scalability). In this case, for example, it is not possible to extract and decode a part of the bitstream, and decoding is always performed in units of bitstreams. In such a case, the attribute data is also sliced into a structure similar to that of the geometry, and encoded independently for each slice so that the attribute can be decoded in units of slices of the geometry. That is, a bitstream is generated for each slice.

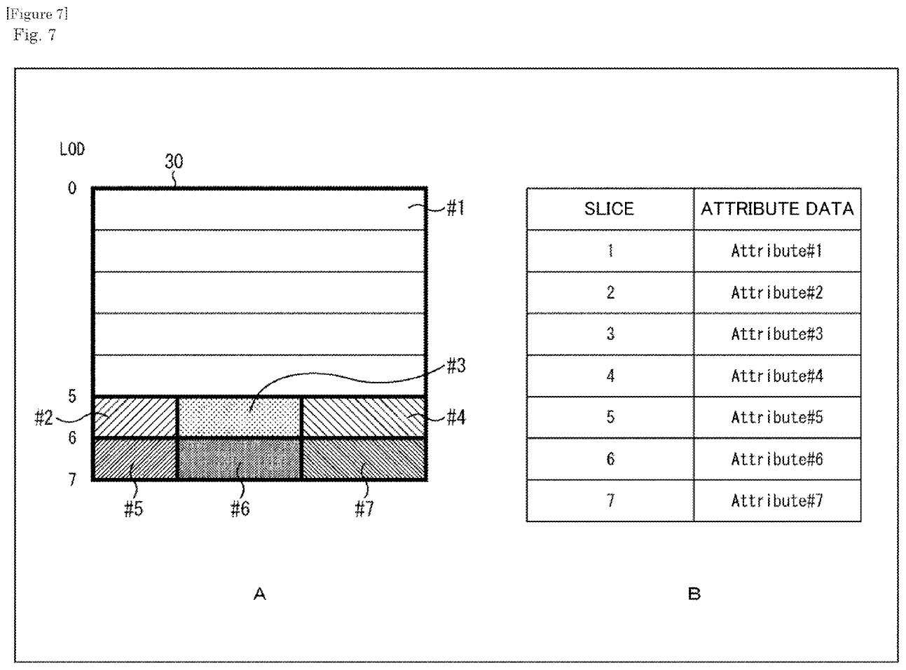

For example, when the geometry data 10 has the tree structure and the slice structure illustrated in FIG. 3, attribute data 30 is also sliced in a similar structure as illustrated in A of FIG. 7. That is, the attribute data 30 is divided into slices #1 to #7. The respective slices are encoded independently of each other and the bitstream (coded data) of the attribute is generated. That is, seven bitstreams of Attribute #1 to Attribute #7 are generated.

An example of attribute correspondence information signaled for such geometry data 10 and attribute data 30, for example, is illustrated in B of FIG. 7. In a table illustrated in B of FIG. 7, identification information of the attribute data corresponding to the identification information of each slice is shown as the attribute correspondence information. In this example (non-scalable), the slice of the geometry and the bitstream of the attribute correspond to one-to-one.

### Attribute Correspondence Information Example 2

Further, a method of encoding the attribute so that the attribute supports scalability (so that the attribute can be decoded in a scalable manner) has also been considered. For example, it is possible to hierarchize the attribute data and cause the attribute data to support scalability by applying a method such as region adaptive hierarchical transform (RAHT) or Lifting. In this case, there is no need to slice the attribute into a geometry-like structure since it is possible to extract and decode a portion of the bitstream. That is, the bitstream of the attribute and the slice of the geometry do not correspond to one-to-one.

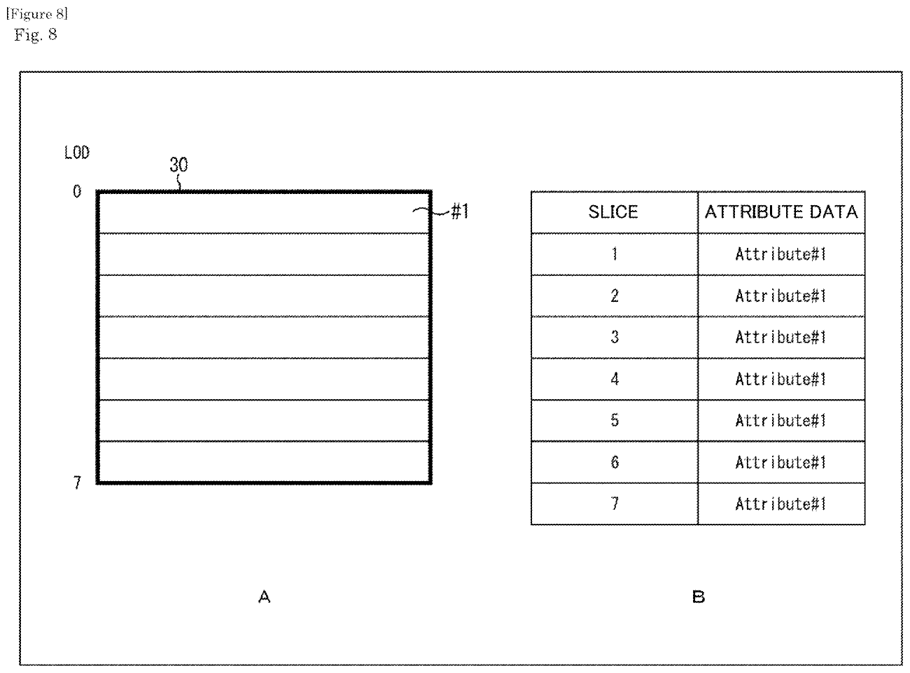

For example, for the geometry data 10 having the tree structure and the slice structure illustrated in FIG. 3, the attribute data 30 may be encoded to generate one bitstream as illustrated in A of FIG. 8. In the case of the example of A in FIG. 8, nodes of all layers of the attribute data 30 are encoded as one slice. That is, one bitstream (Attribute #1) is generated. Since this bitstream supports scalability, it is possible to extract only a portion of the attribute data corresponding to the desired slice of the geometry from this bitstream and decode the portion. That is, it is possible to obtain the attribute data corresponding to any slice of the geometry from the same bitstream.

However, in this case, the scalability of the attribute data is in units of layer (LoD) of the tree structure. That is, it is possible to partially decode the data only in units of layers. To generate a point cloud, it is necessary to prepare the nodes of the geometry data corresponding to all nodes of the decoded attribute data. Therefore, in this case, the geometry data also needs to be decoded up to the same layer as the attribute data.

An example of attribute correspondence information and the like signaled for such geometry data 10 and attribute data 30, for example, is illustrated in B of FIG. 8. In a table illustrated in B of FIG. 8, identification information of the attribute data (bitstream) corresponding to the identification information of each slice is shown as the attribute correspondence information. In this example, the same identification information (Attribute #1) of the attribute data (bitstream) corresponds to each slice.

### Attribute Correspondence Information Example 3

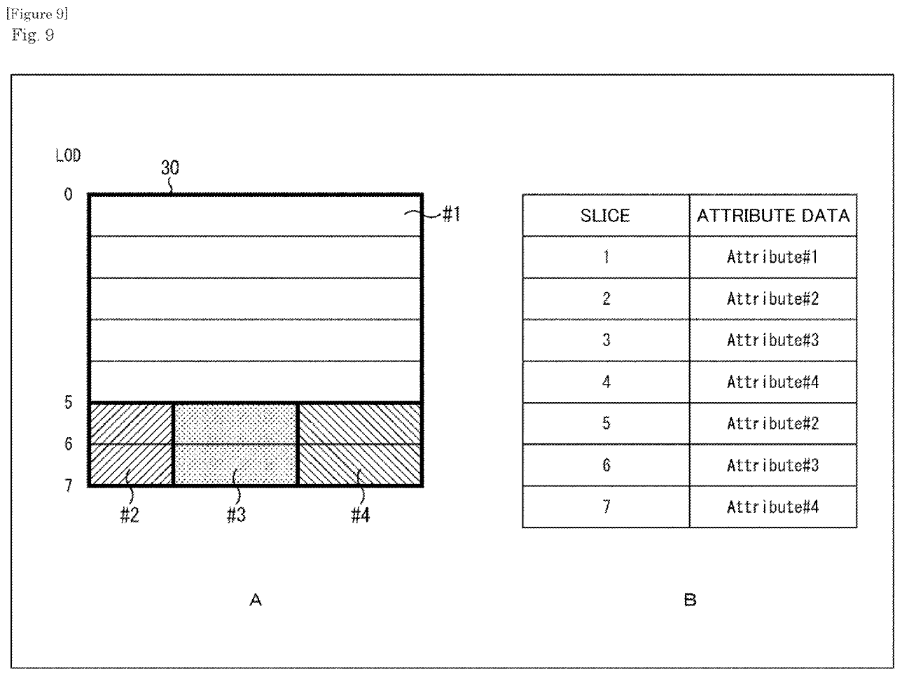

When the attribute supports scalability, the attribute data 30 can also be sliced as illustrated in A of FIG. 9 for the geometry data 10 having the tree structure and the slice structure illustrated in FIG. 3. In the example of A of FIG. 9, the entire LoD 0 to LoD 5, region 1 of LoD 6 and LoD 7, region 2 of LoD 6 and LoD 7, and region 3 of LoD 6 and LoD 7 are each sliced. That is, all nodes of LoD 0 to LoD 5 belong to slice #1, nodes of region 1 of LoD 6 and LoD 7 belong to slice #2, nodes of region 2 of LoD 6 and LoD 7 belong to slice #3, and nodes of region 3 of LoD 6 and LoD 7 belong to slice #4. That is, the attribute data 30 in this case is sliced into a structure different from that of the geometry data 10. However, a slice boundary of the attribute corresponds to a slice boundary of the geometry. That is, each slice of the geometry corresponds to a single slice of the attribute, and each slice of the attribute corresponds to one or more slices of the geometry. The attribute data 30 is encoded independently for each slice. That is, bitstreams (Attribute #1 to Attribute #4) are generated for each slice.

Again, since the bitstream supports scalability, it is possible to extract and decode only the portion of the attribute data corresponding to the desired slice of the geometry from one bitstream. That is, it is possible to obtain the attribute data corresponding to each slice from one bitstream corresponding to a plurality of slices of the geometry.

An example of the attribute correspondence information signaled for such geometry data 10 and attribute data 30, for example, is illustrated in B of FIG. 9. In a table illustrated in B of FIG. 9, identification information of the attribute data (bitstream) corresponding to identification information of each slice is shown as the attribute correspondence information. For example, it is shown that a bitstream (Attribute #1) corresponds to slice 1 of the geometry. Further, it is shown that a bitstream (Attribute #2) corresponds to slice 2 of the geometry. Further, it is shown that a bitstream (Attribute #3) corresponds to slice 3 of the geometry. Further, it is shown that a bitstream (Attribute #4) corresponds to slice 4 of the geometry. Further, it is shown that a bitstream (Attribute #2) corresponds to slice 5 of the geometry. Further, it is shown that a bitstream (Attribute #3) corresponds to slice 6 of the geometry. Further, it is shown that a bitstream (Attribute #4) corresponds to slice 7 of the geometry.

In this example, for LoD 6 and LoD 7, the bitstream of the attribute is divided into respective region (each of regions 1 to 3). Therefore, layers thereof support not only resolution scalability (a method of decoding only some layers of the tree structure), but also region scalability (a method of decoding only some regions).

As described above, it is possible to easily specify the attribute data corresponding to the slice that is a decoding target by referring to the attribute correspondence information regardless of whether or not the bitstream of the attribute is scalable. That is, it is possible to suppress an increase in the load of the decoding processing (typically, to reduce the load) by signaling this attribute correspondence information at the time of encoding. Further, it is possible to suppress an increase in the load of the decoding processing (typically, to reduce the load) by performing processing on the basis of this signaled attribute correspondence information at the time of decoding.

<Signaling of Slice Address Information>

Further, slice address information, which is information indicating a position of the slice in the geometry data, may be signaled. A position of each slice in the geometry data (bitstream) is indicated in the attribute correspondence information. Therefore, by referring to this slice address information, it is possible to easily extract the slice that is a decoding target from the bitstream and decode the slice.

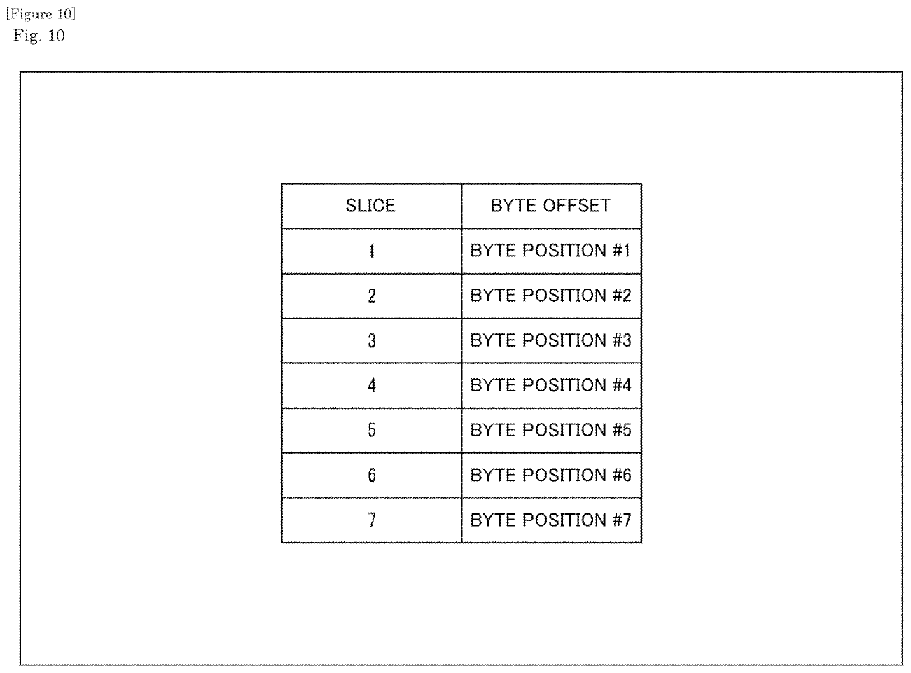

An example of this slice address information is illustrated in FIG. 10. In a table illustrated in FIG. 10, as the slice address information, a position of each slice in the geometry data (bitstream) is indicated as an offset (byte offset) from a beginning of the geometry data (bitstream). Of course, different offset values (byte position #1 to byte position #7) are assigned to the respective slices. By referring to such slice address information, it is possible to easily extract a slice that is a decoding target from the geometry data (bitstream) and decode the slice.

That is, it is possible to suppress an increase in the load of the decoding processing (typically, to reduce the load) by signaling this slice address information at the time of encoding the geometry data. Further, it is possible to suppress an increase in the load of decoding processing (typically, to reduce the load) by performing processing on the basis of this signaled slice address information at the time of decoding the geometry data.

A format of the slice address information is arbitrary and is not limited to the example in FIG. 10. For example, the position of each slice may be represented by information other than the byte offset.

<Signaling of Parallelization Information>

Parallelization information, which is information on parallelization of processing for decoding the geometry data, may also be signaled. The slices can be decoded independently of each other as described above. Therefore, it is possible to decode a plurality of slices in parallel when parallel processing is possible. That is, it is possible to parallelize the geometry data decoding processing in units of slices by performing slicing. By doing so, it is possible to perform the decoding processing at a higher speed.

When the decoding processing is parallelized in this way, the decoding side divides the decoding processing for each slice into groups, and executes the decoding processing for each group in parallel (independently). Grouping of the decoding processing for each slice is performed, for example, so that loads of the respective groups are averaged or performed so that optimization is achieved for predetermined conditions such as hardware constraints, making it possible to perform decoding processing more efficiently (for example, faster). However, to this end, processing such as parsing each slice and ascertaining an amount of load is required on the decoding side.

An example of the grouping is indicated in the parallelization information. Therefore, it is possible to perform grouping so that decoding processing can be performed easily and more efficiently without parsing of each slice, by referring to this parallelization information.

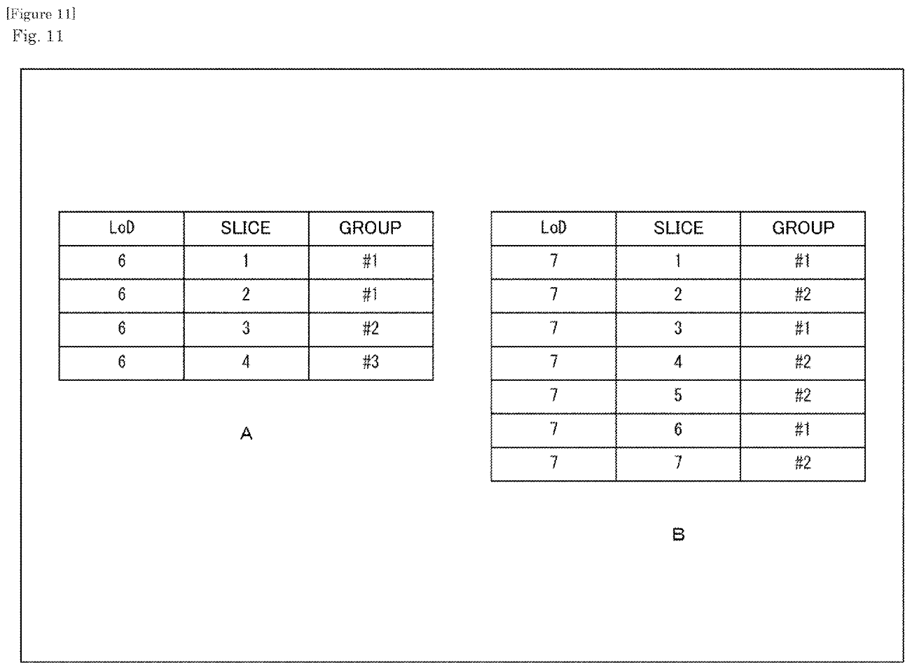

An example of this parallelization information is illustrated in FIG. 11. A table illustrated in A of FIG. 11, a parallelization method in a case in which LoD 0 to LoD 6 are decoded, for geometry data 10 having the tree structure and the slice structure as illustrated in FIG. 3 as parallelization information is illustrated. When decoding up to LoD 6 is performed, slices 1 to 4 may be decoded. Therefore, in the table illustrated in A of FIG. 11, how these slices are grouped is shown. In this example, slices 1 and 2 are assigned to group #1, slice 3 is assigned to group #2, and slice 4 is assigned to group #3. The respective groups can be decoded in parallel with each other.

A table illustrated in B of FIG. 11 shows a parallelization method for decoding LoD 0 to LoD 7 for the geometry data 10 having the tree structure and the slice structure as illustrated in FIG. 3 as the parallelization information. When decoding up to LoD 7 is performed, slices 1 to 7 may be decoded. Therefore, in the table illustrated in B of FIG. 11, how these slices are grouped is shown. In this example, slices 1, 3, and 6 are assigned to group #1, and slices 2, 4, 5, and 7 are assigned to group #2. The respective groups can be decoded in parallel with each other.

It is possible to suppress an increase in the load of the decoding processing (typically, to reduce the load) By signaling this parallelization information at the time of encoding. Further, it is possible to suppress an increase in the load of the decoding processing (typically, to reduce the load) by performing processing on the basis of this signaled parallelization information at the time of decoding.

A method of grouping each slice is arbitrary, and is not limited to the example of FIG. 11. Further, a format of this parallelization information is arbitrary and is not limited to the example in FIG. 11. For example, a grouping pattern may be indicated for each region, instead of a grouping pattern being indicated for each layer as in the example of FIG. 11. Further, the grouping pattern may be indicated for each layer and region, or a grouping pattern may be indicated for each arbitrary unit other than the layer and the region. Further, a plurality of grouping patterns may be indicated for the same data unit (for example, a layer or region). Further, conditions that can be used for selection of the pattern may be indicated.

Further, when the attribute data has the same structure as the geometry data and the parallelization can be performed as in the case of the geometry, parallelization information may also be referred to in decoding the attribute. By doing so, even in decoding of the attribute, it is possible to perform grouping so that decoding processing can be performed more efficiently, easily without parsing each slice.

### 2. First Embodiment

<Encoding Device>

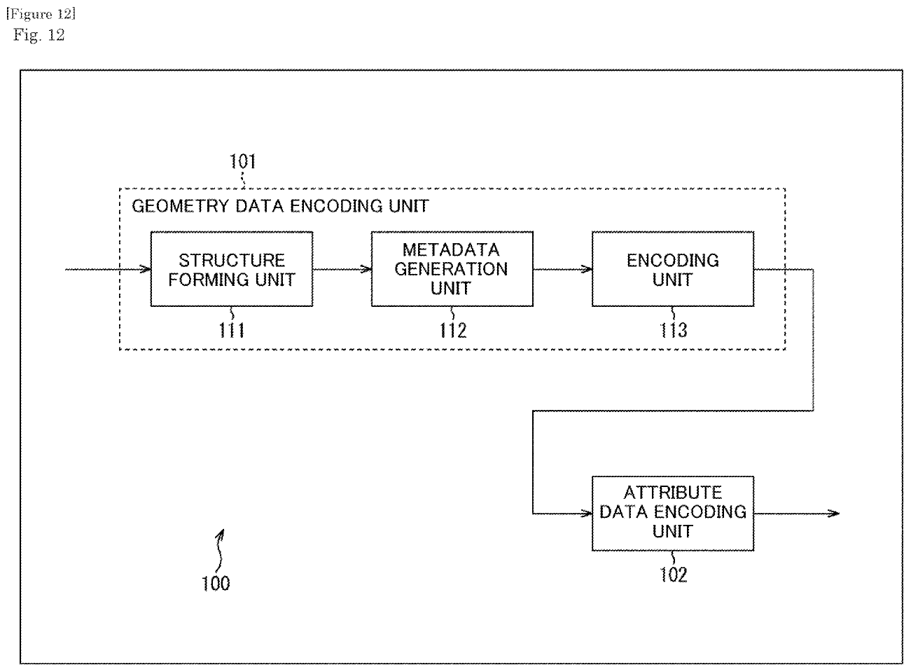

FIG. 12 is a block diagram illustrating an example of a configuration of an encoding device that is an aspect of an information processing device to which the present technology is applied. The encoding device 100 illustrated in FIG. 12 is a device that encodes a point cloud (3D data). The encoding device 100 encodes the point cloud by applying the present technology (for example, various methods described with reference to FIGS. 1 to 11).

Main processing units or flows of data are illustrated in FIG. 12, and all are not illustrated in FIG. 12. That is, processing units not illustrated as blocks in FIG. 12 may be present in the encoding device 100, or processing or data flows not indicated as arrows or the like in FIG. 12 may be present.

As illustrated in FIG. 12, the encoding device 100 includes a geometry data encoding unit 101 and an attribute data encoding unit 102.

The geometry data encoding unit 101 acquires point cloud data (3D data) input to the encoding device 100. The geometry data encoding unit 101 encodes the geometry data (position information) to generate encoded data (bitstream) of the geometry. The geometry data encoding unit 101 also supplies the generated bitstream of the geometry and attribute data (attribute information) to the attribute data encoding unit 102.

The attribute data encoding unit 102 acquires the bitstream of the geometry and the attribute data supplied from the geometry data encoding unit 101. The attribute data encoding unit 102 encodes the attribute data using these to generate encoded data (bitstream) of the attribute. The attribute data encoding unit 102 outputs the bitstream of the geometry and the generated the bitstream of the attribute as a point cloud bitstream to the outside (for example, the decoding side) of the encoding device 100.

<Geometry Data Encoding Unit>

As illustrated in FIG. 12, the geometry data encoding unit 101 includes a structure forming unit 111, a metadata generation unit 112, and an encoding unit 113.

The structure forming unit 111 performs processing regarding formation of the tree structure or the slice structure of the geometry data. For example, the structure forming unit 111 acquires point cloud data input to the encoding device 100. The structure forming unit 111 voxels the geometry data of the acquired point cloud data, converts the geometry data into a tree structure, and converts the geometry data into slices. That is, the structure forming unit 111 forms the tree structure and the slice structure as described with reference to FIGS. 1, 3, 5, and the like. This makes it possible to realize resolution scalability, region scalability, parallel processing, and the like of the geometry decoding. The structure forming unit 111 supplies the geometry data whose tree structure or slice structure has been formed, or the attribute data to the metadata generation unit 112.

The metadata generation unit 112 performs processing regarding generation of the metadata of the geometry data. For example, the metadata generation unit 112 acquires the geometry data or the attribute data supplied from the structure forming unit 111. The metadata generation unit 112 generates metadata for the acquired geometry data. For example, the metadata generation unit 112 generates the slice correspondence information as the metadata. Further, the metadata generation unit 112 can generate the decoding order information, the slice inside information, the attribute correspondence information, the slice address information, the parallelization information, and the like as the metadata. That is, the metadata generation unit 112 can generate the various types of information described with reference to FIGS. 1 to 11 as the metadata. Of course, the metadata generation unit 112 may generate information other than these as the metadata. The metadata generation unit 112 supplies the generated metadata to the encoding unit 113 together with the geometry data and the attribute data.

The encoding unit 113 performs processing regarding encoding. For example, the encoding unit 113 acquires the geometry data, the metadata, and the attribute data supplied from the metadata generation unit 112. The encoding unit 113 encodes the acquired geometry data to generate encoded data (bitstream) of the geometry. Further, the encoding unit 113 includes the acquired metadata in the bitstream. That is, the encoding unit 113 signals the slice correspondence information as the metadata. Further, the encoding unit 113 can signal the decoding order information, the slice inside information, the attribute correspondence information, the slice address information, the parallelization information, and the like as the metadata. That is, the encoding unit 113 can signal the various types of information described with reference to FIGS. 1 to 11 as the metadata. This encoding method is arbitrary. The encoding unit 113 may encode the metadata. The encoding unit 113 supplies the attribute data and the generated geometry data to the attribute data encoding unit 102.

With the configuration as described above, since the encoding device 100 can signal the various types of information described with reference to FIGS. 1 to 11 as the metadata, it is possible to suppress an increase in the load of the decoding processing (typically, to reduce the load).

These processing units (the geometry data encoding unit 101 (the structure forming units 111 to the encoding units 113) and the attribute data encoding unit 102) have arbitrary configurations. For example, each processing unit may be configured of a logic circuit that realizes the above processing. Further, each processing unit may include, for example, a central processing unit (CPU), a read only memory (ROM), a random access memory (RAM), and the like, and execute a program using these to realize the above processing. Of course, each processing unit may have both the configurations to realize some of the above-described processing using a logic circuit, and realize others by executing a program. The configurations of the respective processing units may be independent of each other. For example, some of the processing units may realize some of the above-described processing by using a logic circuit, other some of the processing units may realize the above-described processing by executing a program, and yet other some of the processing units may realize the above-described processing both by using the logic circuit and by executing the program.

<Flow of Encoding Processing>

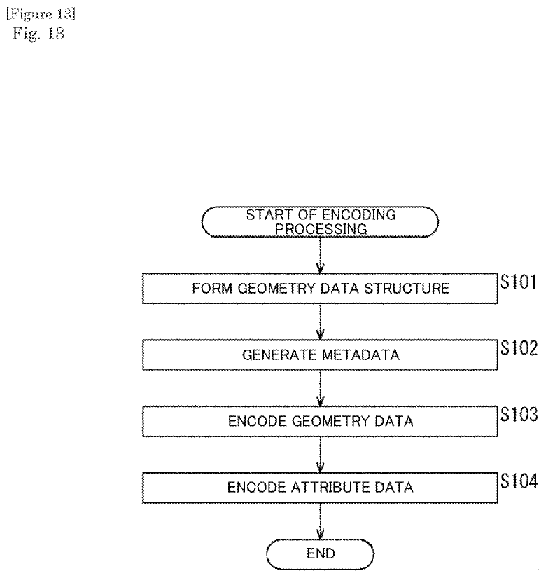

The encoding device 100 encodes point cloud data by executing encoding processing. An example of the flow of the encoding processing will be described with reference to the flowchart of FIG. 13.

When the encoding processing is started, the structure forming unit 111 of the encoding device 100 voxels the input geometry data of the point cloud, converts the geometry data into a tree structure, and converts the geometry data into slices in step S101. That is, the structure forming unit 111 forms the tree structure and the slice structure for the geometry data.

In step S102, the metadata generation unit 112 generates metadata for the geometry data whose tree structure and slice structure have been formed in step S101. In this case, the metadata generation unit 112 generates the slice correspondence information as the metadata, for example. Further, the metadata generation unit 112 can generate the decoding order information, the slice inside information, the attribute correspondence information, the slice address information, the parallelization information, and the like as the metadata. That is, the metadata generation unit 112 can generate the various types of information described with reference to FIGS. 1 to 11 as the metadata.

In step S103, the encoding unit 113 encodes the geometry data whose tree structure and slice structure have been formed in step S101 to generate encoded data (bitstream) of the geometry. Further, the encoding unit 113 includes the metadata generated in step S102 in the bitstream. For example, the encoding unit 113 includes slice correspondence information in the bitstream. Further, the encoding unit 113 can include the decoding order information, the slice inside information, the attribute correspondence information, the slice address information, the parallelization information, and the like in the bitstream. That is, the encoding unit 113 can signal the various types of information described with reference to FIGS. 1 to 11 as the metadata.

In step S104, the attribute data encoding unit 102 encodes the input attribute data of the point cloud to generate the encoded data (bitstream) of the attribute. When the processing of step S104 ends, the encoding processing ends.

Executing the encoding processing as described above enables the encoding device 100 to signal the various types of information described with reference to FIGS. 1 to 11 as metadata, making it possible to suppress an increase in the load of the decoding processing (typically, to reduce the load).

### 3. Second Embodiment

<Decoding Device>

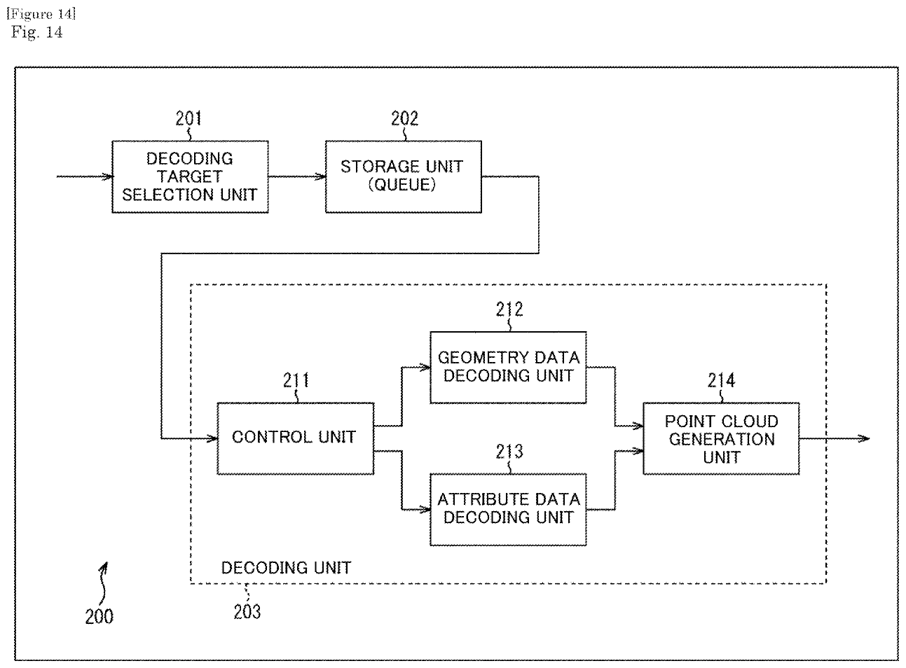

FIG. 14 is a block diagram illustrating an example of a configuration of a decoding device, which is an aspect of the information processing device to which the present technology is applied. The decoding device 200 illustrated in FIG. 14 is a device that decodes encoded data of a point cloud (3D data). The decoding device 200 is a decoding device corresponding to the encoding device 100, and decodes the encoded data using a decoding method corresponding to the encoding method to which the encoding device 100 is applied. That is, the decoding device 200 can decode the encoded data (bitstream) of the point cloud generated by the encoding device 100 to generate point cloud data. That is, the decoding device 200 applies the present technology (for example, various methods described with reference to FIGS. 1 to 11) to decode the encoded data of the point cloud.

Main processing units or flows of data are illustrated in FIG. 14, and all are not illustrated in FIG. 14. That is, processing units not illustrated as blocks in FIG. 14 may be present in the decoding device 200, or processing or data flows not indicated as arrows or the like in FIG. 14 may be present.

As illustrated in FIG. 14, the decoding device 200 includes a decoding target selection unit 201, a storage unit 202, and a decoding unit 203.

The decoding target selection unit 201 performs processing regarding selection of the decoding target. For example, the decoding target selection unit 201 acquires the encoded data (bitstream) of the point cloud input to the decoding device 200. This bitstream includes the bitstream of the geometry and the bitstream of the attribute. The bitstream of the geometry is obtained by encoding the geometry data whose tree structure and slice structure have been formed as described above. The bitstream also includes slice correspondence information as the metadata. Further, the bitstream may include the decoding order information, the slice inside information, the attribute correspondence information, the slice address information, the parallelization information, and the like as the metadata. That is, the various types of information described with reference to FIGS. 1 to 11 can be signaled for the geometry.

The decoding target selection unit 201 selects a slice that is the decoding target on the basis of the metadata of the geometry. For example, the decoding target selection unit 201 selects, as the decoding target, a slice corresponding to the resolution and region of the geometry that is the decoding target on the basis of the signaled slice correspondence information. The resolution and the region of the geometry that is a decoding target may be set arbitrarily. For example, the resolution and the region may be designated by a user or the like, or may be set on the basis of a movement of a viewpoint at the time of reproduction, or the like. Further, the decoding target selection unit 201 may select the slice that is the decoding target on the basis of the signaled decoding order information, slice inside information, parallelization information, and the like. That is, the decoding target selection unit 201 may select the slice that is the decoding target on the basis of the various types of information described with reference to FIGS. 1 to 11.

The decoding target selection unit 201 extracts a portion (encoded data) corresponding to the slice from the bitstream of the geometry, and supplies the extracted portion to the storage unit 202. The decoding target selection unit 201 can extract the portion (encoded data) corresponding to this slice on the basis of the signaled slice address information.

Further, the decoding target selection unit 201 specifies the bitstream of the attribute corresponding to the selected slice of the geometry, and supplies the bitstream of the attribute to the storage unit 202. The decoding target selection unit 201 can specify the bitstream of the attribute on the basis of the signaled attribute correspondence information.

This metadata may be encoded. In that case, the decoding target selection unit 201 decodes the encoded data of the metadata to obtain the metadata. Further, the decoding target selection unit 201 supplies the metadata of the geometry data to the decoding unit 203.

The storage unit 202 may include an arbitrary storage medium such as a hard disk or semiconductor memory, and store the data supplied from the decoding target selection unit 201. For example, the storage unit 202 may store encoded data of the slice of the geometry selected as the decoding target by the decoding target selection unit 201, the bitstream of the attribute corresponding to the slice, or the like. The storage unit 202 manages data using a first-in and first-out scheme. Therefore, this storage unit 202 forms a queue. In response to a request from the decoding unit 203, the storage unit 202 supplies previously stored data (the encoded data of the slice of the geometry selected as the decoding target, or the bitstream of the attribute corresponding to the slice) to the decoding unit 203.

The decoding unit 203 performs processing regarding decoding. For example, the decoding unit 203 acquires the encoded data of the geometry or the bitstream of the attribute stored in the storage unit 202, and decodes these to generate the geometry data or the attribute data. The decoding unit 203 also reconstructs a point cloud using the generated geometry data and attribute data, and outputs point cloud data.

As illustrated in FIG. 14, the decoding unit 203 includes a control unit 211, a geometry data decoding unit 212, an attribute data decoding unit 213, and a point cloud generation unit 214.

The control unit 211 performs processing regarding decoding control. For example, the control unit 211 acquires the encoded data of the geometry or the bitstream of the attribute stored in the storage unit 202. As described above, the encoded data of the slice of the geometry selected as the decoding target by the decoding target selection unit 201, the bitstream of the attribute corresponding to the slice, and the like are stored in the storage unit 202. The control unit 211 acquires the information that has been first stored. A timing at which the control unit 211 acquires data from the storage unit 202 is arbitrary.

The control unit 211 also supplies the obtained encoded data of the slice of the geometry to the geometry data decoding unit 212. Further, the control unit 211 supplies the acquired the bitstream of the attribute to the attribute data decoding unit 213.

The geometry data decoding unit 212 performs processing regarding decoding of the encoded data of the geometry. For example, the geometry data decoding unit 212 acquires the encoded data of the geometry supplied from the control unit 211 (that is, the encoded data of the slice selected as the decoding target).

The geometry data decoding unit 212 decodes the acquired encoded data to generate geometry data. The geometry data decoding unit 212 can parallelize the processing for decoding the encoded data of the geometry in units of slices.

That is, the geometry data decoding unit 212 can group the slices that are decoding targets on the basis of the signaled slice inside information or parallelization information. The geometry data decoding unit 212 can decode the acquired encoded data of the slice of the geometry in a thread corresponding to the group to which the slices are assigned. The geometry data decoding unit 212 supplies the generated geometry data to the point cloud generation unit 214.

The attribute data decoding unit 213 performs processing regarding decoding of the bitstream of the attribute. For example, the attribute data decoding unit 213 acquires the bitstream of the attribute supplied from the control unit 211 (that is, the bitstream of the attribute corresponding to the slice selected as the decoding target).

The attribute data decoding unit 213 decodes the acquired bitstream to generate the attribute data. This bitstream may or may not support scalability. When the bitstream of the attribute supports scalability of the resolution, the region, or the like, the attribute data decoding unit 213 can extract and decode only a necessary part from the bitstream. The attribute data decoding unit 213 supplies the generated attribute data to the point cloud generation unit 214.

The point cloud generation unit 214 performs processing regarding generation of the point cloud. For example, the point cloud generation unit 214 acquires the geometry data supplied from the geometry data decoding unit 212. Further, the point cloud generation unit 214 acquires the attribute data supplied from the attribute data decoding unit 213. The point cloud generation unit 214 generates point cloud data (reconstructs the point cloud) using the acquired geometry data and attribute data. The point cloud generation unit 214 outputs the generated point cloud data.

With the above configuration, the decoding device 200 can perform the decoding processing on the basis of the signaled metadata (the various types of information described with reference to FIGS. 1 to 11), making it possible to suppress an increase in the load of the decoding processing (typically, to reduce the load).

These processing units (the decoding target selection unit 201, the storage unit 202, and the decoding unit 203 (the control unit 211 to the point cloud generation unit 214)) have arbitrary configurations. For example, each processing unit may be configured by a logic circuit that realizes the above processing. Further, each processing unit may include, for example, a CPU, a ROM, a RAM, and the like, and may realize the above-described processing by executing a program using these. Of course, each processing unit may have both the configurations to realize some of the above-described processing using a logic circuit, and realize others by executing a program. The configurations of the respective processing units may be independent of each other. For example, some of the processing units may realize some of the above-described processing by using a logic circuit, other some of the processing units may realize the above-described processing by executing a program, and yet other some of the processing units may realize the above-described processing both by using the logic circuit and by executing the program.

<Flow of Decoding Processing>

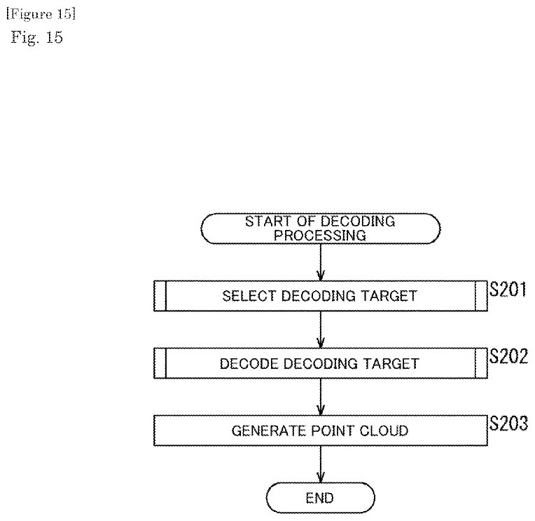

The decoding device 200 decodes the encoded data (bitstream) of the point cloud by executing the decoding processing. An example of a flow of this decoding processing will be described with reference to a flowchart of FIG. 15.

When the decoding processing is started, the decoding target selection unit 201 of the decoding device 200 executes decoding target selection processing in step S201. Through this decoding target selection processing, the decoding target selection unit 201 selects a slice that is a decoding target for the geometry, for example. The decoding device 200 also extracts a portion corresponding to the slice from the input bitstream of the geometry. Further, the decoding target selection unit 201 specifies the bitstream of the attribute corresponding to the selected slice of the geometry. The decoding target selection unit 201 causes the storage unit 202 to store the encoded data of the selected slice of the geometry and the specified bitstream of the attribute.

In step S202, the decoding unit 203 executes decoding target decoding processing to decode the decoding target selected in step S201.

In step S203, the decoding unit 203 (the point cloud generation unit 214) generates point cloud data (reconstructs the point cloud) using the geometry data and the attribute data obtained through the processing in step S202. When the processing of step S203 ends, the decoding processing ends.

<Flow of Decoding Target Selection Processing>

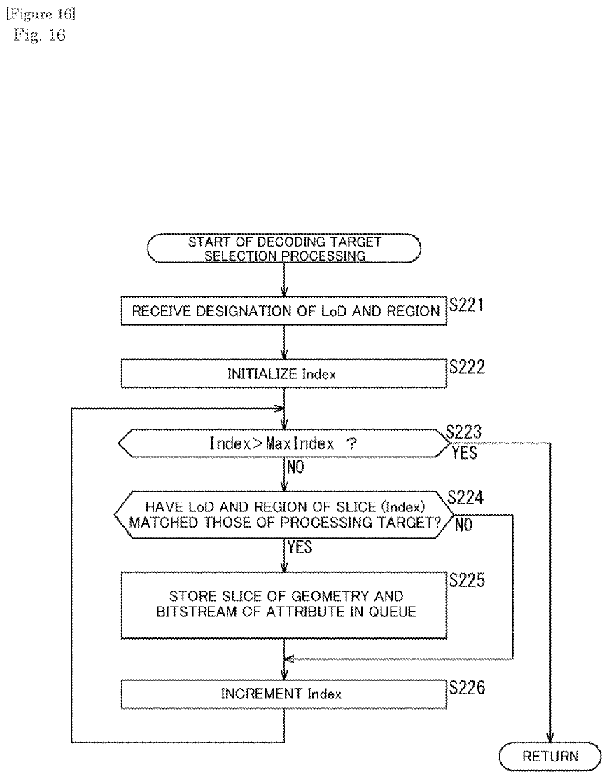

Next, an example of a flow of decoding target selection processing executed in step S201 of FIG. 15 will be described with reference to the flowchart of FIG. 16.

When the decoding target selection processing is started, the decoding target selection unit 201 receives designation of LoD and region that are decoding targets in step S221. This designation, for example, may be performed by the user, may be performed by other processing, or may be set in advance.

When the designation of the LoD and the region to be decoded (to reconstruct the point cloud) is received, the decoding target selection unit 201 initializes a variable index for counting slices that are processing targets (for example, Index=0) in step S222. The decoding target selection unit 201 determines whether the respective slices of the geometry are set as sequential processing targets using this variable index, and the slice that is the processing target is set as a decoding target in the following processing.

As described above, the bitstream of the geometry is the encoded data of the geometry whose tree structure and slice structure have been formed. The bitstream also includes slice correspondence information as the metadata. Further, the bitstream may include the decoding order information, the slice inside information, the attribute correspondence information, the slice address information, the parallelization information, and the like as the metadata. That is, the various types of information described with reference to FIGS. 1 to 11 can be signaled for the geometry. The decoding target selection unit 201 selects a slice that is a decoding target on the basis of the metadata.

In step S223, the decoding target selection unit 201 determines whether or not a value of the variable index is greater than a maximum value MaxIndex. Since the variable index is a variable for counting slices that are processing targets, a maximum value thereof matches (the number of the slice of the geometry⋅1). That is, the decoding target selection unit 201 determines whether or not all the slices have been processed in this processing. When a determination is made that the value of the variable index is equal to or smaller than the maximum value MaxIndex and there is an unprocessed slice, the processing proceeds to step S224.

In step S224, the decoding target selection unit 201 determines whether or not the LoD and the region of the slice that are processing targets match the LoD and the region that are decoding targets received in step S221. First, the decoding target selection unit 201 selects an unprocessed slice as the processing target. For example, the decoding target selection unit 201 controls a selection order on the basis of the signaled slice correspondence information, decoding order information, slice inside information, parallelization information, and the like. That is, the decoding target selection unit 201 optimizes the decoding order of the slices that are decoding targets by referring to the signaled information, and selects unprocessed slices as processing targets in an order such that the slices that are decoding targets are obtained in the decoding order. By doing so, the decoding target selection unit 201 can easily control the decoding order of the slices that are the decoding target without parsing the entire bitstream of the geometry.

When the LoD and the region of the selected slice that is the processing target match the LoD and the region that are decoding targets received in step S221, the decoding target selection unit 201 sets the slice as the decoding target. Thus, when the slice that is the processing target corresponds to the LoD and the region that are decoding targets, the processing proceeds to step S225.

The decoding target selection unit 201 performs this determination on the basis of the signaled slice correspondence information. Therefore, the decoding target selection unit 201 can easily specify the LoD and the region to which the slice that is the processing target corresponds without parsing the entire bitstream of the geometry. That is, the decoding target selection unit 201 can easily determine whether or not the LoD and the region of the slice that are processing targets match the LoD and the region that are decoding targets. That is, the decoding target selection unit 201 can easily select the slice that is the decoding target.

Further, the decoding target selection unit 201 can refer to the signaled decoding order information to perform this determination. That is, the decoding target selection unit 201 may easily select the slice that is the decoding target on the basis of the various types of information described with reference to FIGS. 1 to 11.

In step S225, the decoding target selection unit 201 stores the slice of the geometry and the bitstream of the attribute in a queue. For example, the decoding target selection unit 201 extracts the portion (encoded data) corresponding to the slice selected as the decoding target in step S224 from the bitstream of the geometry. In this case, the decoding target selection unit 201 can easily extract the portion (encoded data) corresponding to the slice selected as the decoding target in step S224 from the bitstream of the geometry on the basis of the signaled slice address information.

Further, the decoding target selection unit 201 specifies the bitstream of the attribute corresponding to the slice. In this case, the decoding target selection unit 201 can easily specify the bitstream of the attribute corresponding to the slice selected as the decoding target in step S224 on the basis of the signaled attribute correspondence information.

The decoding target selection unit 201 causes the storage unit 202 to store the extracted encoded data of the slice of the geometry and the specified bitstream of the attribute.

When the processing of step S225 ends, the processing proceeds to step S226. When a determination is made in step S224 that the LoD and region of the slice that is the processing target do not match the LoD and region that are decoding targets received in step S221, the processing proceeds to step S226.

In step S226, the decoding target selection unit 201 increments (for example, +1) the variable index. When the variable index is incremented, the processing returns to step S223 and subsequent processing is repeated.

That is, respective processing from step S223 to step S226 is executed for each slice of the geometry. Then, in step S223, when a determination is made that the value of the variable index is greater than the maximum value MaxIndex, that is, all slices are processing targets, the decoding target selection processing ends, and the processing returns to FIG. 15.

The decoding target selection unit 201 may control order in which data of the respective slices selected as the decoding targets is stored in the queue, instead of controlling order of selection of the slices that are processing targets, on the basis of slice correspondence information, decoding order information, slice inside information, parallelization information, and the like. In this case, in step S225, the decoding target selection unit 201 can store the extracted encoded data of the slice of the geometry and the specified bitstream of the attribute in the storage unit 202 in order of slices based on the signaled slice correspondence information, decoding order information, slice inside information, and parallelization information. Therefore, the decoding target selection unit 201 can easily control the slice order to be stored in the storage unit 202 without parsing the entire bitstream.

<Flow of Decoding Target Decoding Processing>

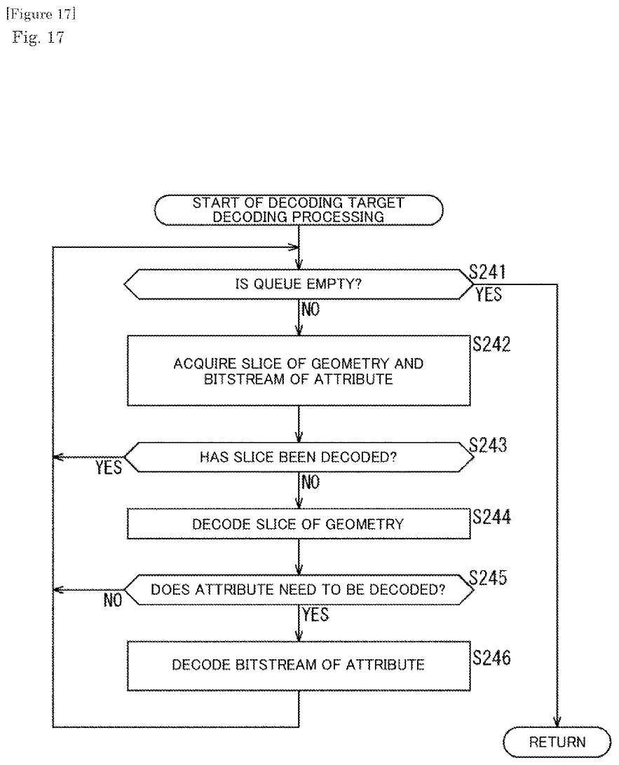

Next, an example of a flow of the decoding target decoding processing executed in step S202 of FIG. 15 will be described with reference to the flowchart of FIG. 17.

When the decoding target decoding processing is started, the control unit 211 determines whether or not the queue is empty in step S241. That is, the control unit 211 determines whether or not the data of the geometry or the attribute is stored in the storage unit 202. When a determination is made that the queue is not empty, that is, data is stored, the processing proceeds to step S242.

In step S242, the control unit 211 acquires from the queue (the storage unit 202) the encoded data of the slice of the geometry that has been first stored and the bitstream of the attribute corresponding to that slice.

In step S243, the control unit 211 determines whether or not the slice has been decoded. When a determination is made that the data has not yet been decoded, the processing proceeds to step S244.

In step S244, the geometry data decoding unit 212 decodes the encoded data of the slice of the geometry acquired in step S242 to generate the geometry data of the slice. For example, the geometry data decoding unit 212 can group the slices that are decoding targets on the basis of the signaled slice inside information or parallelization information. The geometry data decoding unit 212 can decode the acquired encoded data of the slice of the geometry in a thread corresponding to the group to which the slices are assigned. By doing so, the geometry data decoding unit 212 can more efficiently parallelize geometry decoding, easily without parsing the entire bitstream.

In step S245, the control unit 211 determines whether or not the attribute needs to be decoded. When a determination is made that the attribute corresponding to that slice has not yet been decoded, the processing proceeds to step S246.

In step S246, the attribute data decoding unit 213 decodes the bitstream of the attribute acquired in step S242 to generate the attribute data.

When step S246 ends, the processing returns to step S241. When a determination is made in step S245 that the attribute corresponding to the slice has already been decoded and the attribute decoding is unnecessary, the processing returns to step S241. Further, when a determination is made in step S243 that the slice has been decoded, the processing returns to step S241. As described above, each processing from step S241 to step S246 is executed for the data of each slice stored in the queue. When a determination is made in step S241 that the queue is empty, that is, when a determination is made that no data is stored in the storage unit 202, all the slices selected as the decoding targets have been decoded, and therefore, the decoding target decoding processing ends, and the processing returns to FIG. 15.

By executing each processing as described above, the decoding device 200 can perform the decoding processing on the basis of the signaled metadata (the various types of information described with reference to FIGS. 1 to 11), making it possible to suppress an increase in the load of the decoding processing (typically, to reduce the load).

### 4. Supplements

<Distribution>

The decoding target selection processing and the decoding target decoding processing described above may be executed by different devices. For example, a distribution server that distributes point cloud data may perform the decoding target selection processing and select slices corresponding to the LoD and the region requested by a client. The distribution server may transmit encoded data (bitstream) of the geometry or the attribute corresponding to the selected slice to the client together with various types of information described with reference to FIGS. 1 to 11, such as the slice correspondence information. The client may receive these and decode the bitstream of the geometry or the attribute on the basis of the various types of information described with reference to FIGS. 1 to 11, such as the signaled slice correspondence information. By doing so, it is possible to transmit only data that is a decoding target, and thus, it is possible to suppress (typically reduce) an increase in a transmission load. The same applies to a case of storage in a storage medium (that is, a case in which a bitstream is transmitted from the encoding side to the decoding side via a storage medium).

<Metadata>

The various types of information described with reference to FIGS. 1 to 11, such as the slice correspondence information, may be included in the bitstream of the geometry as described above, or may be signaled as data separate from the bitstream of the geometry.

<Computer>

The above-described series of processing can be executed by hardware or can be executed by software. When the series of processing is executed by software, a program that constitutes the software is installed in the computer. Here, the computer includes, for example, a computer built into dedicated hardware, or a general-purpose personal computer capable of executing various functions by various programs being installed.

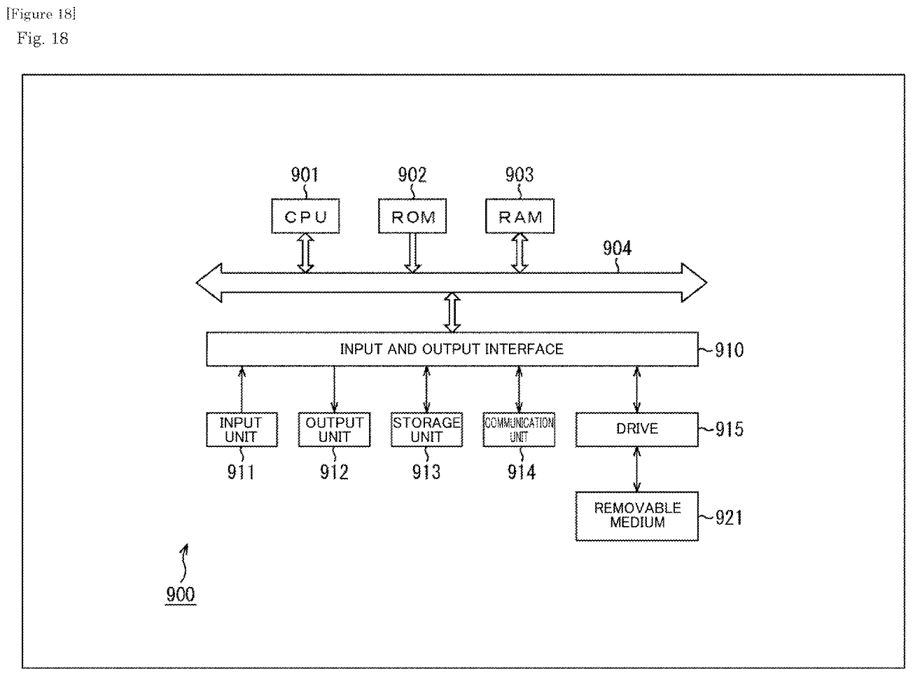

FIG. 18 is a block diagram illustrating a configuration example of computer hardware that executes the above-described series of processing using a program.

In a computer 900 illustrated in FIG. 18, a central processing unit (CPU) 901, a read only memory (ROM) 902, and a random access memory (RAM) 903 are connected to each other via a bus 904.

An input and output interface 910 is also connected to the bus 904. An input unit 911, an output unit 912, a storage unit 913, a communication unit 914, and a drive 915 are connected to the input and output interface 910.

The input unit 911 includes, for example, a keyboard, a mouse, a microphone, a touch panel, or an input terminal. The output unit 912 includes, for example, a display, a speaker, or an output terminal. The storage unit 913 includes, for example, a hard disk, a RAM disk, or a non-volatile memory. The communication unit 914 includes, for example, a network interface. The drive 915 drives a removable medium 921 such as a magnetic disk, an optical disc, a magneto-optical disc, or a semiconductor memory.

In the computer configured as described above, the CPU 901 loads a program stored in the storage unit 913 into the RAM 903 via the input and output interface 910 and the bus 904 and executes the program, so that the above-described series of processing is performed. Further, data and the like necessary for the CPU 901 to execute various types of processing are appropriately stored in the RAM 903.

The program to be executed by the computer, for example, can be recorded on the removable medium 921 such as a package medium and applied. In this case, the program can be installed in the storage unit 913 via the input and output interface 910 by the removable medium 921 being mounted in the drive 915.

This program can also be provided via wired or wireless transfer medium such as a local region network, the Internet, and digital satellite broadcasting. In this case, the program can be received by the communication unit 914 and installed in the storage unit 913.

Alternatively, this program can be installed in the ROM 902 or the storage unit 913 in advance.

<Application Target of Present Technology>

Although a case in which the present technology is applied to encoding and decoding of the point cloud data has been described above, the present technology is not limited to these examples and can be applied to encoding and decoding of 3D data having any standard. For example, in encoding and decoding of mesh data, the mesh data may be converted into point cloud data, and encoding and decoding may be performed by applying the present technology. That is, specifications of various processing such as encoding and decoding methods and various types of data such as 3D data or metadata are arbitrary as long as these do not conflict with the present technology described above. Further, some of the processing or specifications described above may be omitted as long as this does not conflict with the present technology.

The present technology can be applied to any configuration. For example, the present technology can be applied to various electronic devices such as a transmitter or a receiver (for example, a television receiver or a mobile phone) in satellite broadcasting, cable broadcasting such as a cable TV, distribution on the Internet, distribution to a terminal by cellular communication, or the like, or devices (for example, a hard disk recorder or a camera) that record images on a medium such as an optical disc, a magnetic disk, and a flash memory, and reproduce the images from the storage medium.

Further, for example, the present technology can be implemented as a part of the configuration of the device, such as a processor (for example, a video processor) as a system large scale integration (LSI) or the like, a module (for example, a video module) using a plurality of processors or the like, a unit (for example, a video unit) using a plurality of modules or the like, or a set (for example, a video set) in which other functions are added to the unit.

Further, for example, the present technology can also be applied to a network system configured of a plurality of devices. For example, the present technology may be implemented as cloud computing in which a plurality of devices share processing and jointly perform processing via a network. For example, the present technology may be implemented in a cloud service in which a service regarding images (moving images) is provided to arbitrary terminals such as computers, audio visual (AV) device, portable information processing terminals, and Internet of Things (IoT) devices.

In the present specification, the system means a set of a plurality of components (devices, modules (parts), and the like), and it does not matter whether all the components are present in the same housing. Therefore, a plurality of devices housed in separate housings and connected via a network, and a single device in which a plurality of modules are housed in one housing are both systems.

<Field and Use to Which Present Technology Can Be Applied>

Systems, devices, processing units, and the like to which the present technology are applied can be used in any field, such as transportation, medical care, crime prevention, agriculture, livestock industry, mining, beauty, factories, home appliances, weather, and nature monitoring. Further, the use thereof is arbitrary.

<Others>

Embodiments of the present technology are not limited to the above-described embodiments, and various changes can be made without departing from the gist of the present technology.

For example, a configuration described as one device (or processing unit) may be divided and configured as a plurality of devices (or processing units). On the other hand, the configuration described above as a plurality of devices (or processing units) may be collectively configured as one device (or processing unit). Further, of course, a configuration other than the above may be added to the configuration of each device (or each processing unit). Further, a part of a configuration of a device (or processing unit) may be included in a configuration of another device (or another processing unit) as long as a configuration or operation of the system as a whole is substantially the same.

Further, for example, the above-described program may be executed in any device. In this case, the device only needs to have necessary functions (functional blocks, and the like) and to be able to obtain necessary information.

Further, for example, each step of one flowchart may be executed by one device, or may be shared and executed by a plurality of devices. Further, when a plurality of processing are included in one step, one device may execute the plurality of processing, or the plurality of devices may share and execute the plurality of processing. In other words, it is also possible to execute the plurality of processing included in one step as processing of a plurality of steps. On the other hand, it is also possible to execute processing described as a plurality of steps collectively as one step.

Further, for example, in a program that is executed by a computer, processing of steps describing the program may be executed in time series in an order described in the present specification, or may be executed in parallel or individually at a required timing such as when call is made. That is, the processing of the respective steps may be executed in an order different from the above-described order as long as there is no contradiction. Further, the processing of the steps describing this program may be executed in parallel with processing of another program, or may be executed in combination with the processing of the other program.

Further, for example, a plurality of technologies regarding the present technology can be independently implemented as a single body as long as there is no contradiction. Of course, it is also possible to perform any plurality of the present technologies in combination. For example, it is also possible to implement some or all of the present technologies described in any of the embodiments in combination with some or all of the present technologies described in other embodiments. Further, it is also possible to implement some or all of any of the present technologies described above in combination with other technologies not described above.

The present technology can also take the following configuration.

(1) An information processing device including:
a slice correspondence information generation unit configured to generate slice correspondence information, the slice correspondence information being information indicating a slice of geometry data corresponding to a resolution and a region of a geometry, for a point cloud representing an object having a three-dimensional shape as a set of points; and
an encoding unit configured to encode the geometry data to generate a bitstream of the geometry including the slice correspondence information generated by the slice correspondence information generation unit.

(2) The information processing device according to (1), wherein the slice correspondence information is information indicating the slice corresponding to the resolution and the region using identification information of the slice.

(3) The information processing device according to (1),
wherein the slice correspondence information generation unit further generates decoding order information, the decoding order information being information on the decoding order of the slices corresponding to the resolution and the region, and
the encoding unit further includes the decoding order information in the bitstream.

(4) The information processing device according to (1),
wherein the slice correspondence information generation unit further generates slice inside information, the slice inside information being information on the inside of the slice, and
the encoding unit further includes the slice inside information in the bitstream.

(5) The information processing device according to (4), wherein the slice inside information includes number-of-points information, the number-of-points information being information indicating the number of points in the slice.

(6) The information processing device according to (1),
wherein the slice correspondence information generation unit further generates attribute correspondence information, the attribute correspondence information being information indicating attribute data corresponding to the slice, and
the encoding unit further includes the attribute correspondence information in the bitstream.

(7) The information processing device according to (6), wherein the attribute correspondence information is information indicating the attribute data using identification information of a bitstream of an attribute.

(8) The information processing device according to (1),
wherein the slice correspondence information generation unit further generates slice address information, the slice address information being information indicating a position of the slice in the geometry data, and
the encoding unit further includes the slice address information in the bitstream.

(9) The information processing device according to (1),
wherein the slice correspondence information generation unit further generates parallelization information, the parallelization information being information on parallelization of decoding processing, and
the encoding unit further includes the parallelization information in the bitstream.

(10) An information processing method including:
generating slice correspondence information, the slice correspondence information being information indicating a slice of geometry data corresponding to a resolution and a region of a geometry, for a point cloud representing an object having a three-dimensional shape as a set of points; and
encoding the geometry data to generate a bitstream of the geometry including the generated slice correspondence information.

(11) An information processing device including:
a decoding target selection unit configured to select, as a decoding target, a slice of geometry data corresponding to a resolution and a region of a geometry as a decoding target from a bitstream of the geometry, on the basis of slice correspondence information, the slice correspondence information being information indicating the slice of the geometry data corresponding to the resolution and the region of the geometry, for a point cloud representing an object having a three-dimensional shape as a set of points; and
a decoding unit configured to decode the slice selected by the decoding target selection unit.

(12) The information processing device according to (11),
wherein the slice correspondence information is information indicating the slice corresponding to the resolution and the region using identification information of the slice, and
the decoding target selection unit performs the selection of the slice as a decoding target using identification information of the slice corresponding to the resolution and the region as a decoding target, the identification information being indicated in the slice correspondence information.

(13) The information processing device according to (11) or (12),
wherein the decoding target selection unit performs the selection of the slice as a decoding target in a decoding order indicated by decoding order information, the decoding order information being information on the decoding order of the slice corresponding to the resolution and the region.

(14) The information processing device according to any one of (11) to (13),
wherein the decoding unit parallelizes decoding processing of the plurality of slices selected by the decoding target selection unit on the basis of slice inside information, the slice inside information being information on the inside of the slice.

(15) The information processing device according to (14), wherein the decoding unit parallelizes the decoding processing of the plurality of slices selected by the decoding target selection unit on the basis of number-of-points information, the number-of-points information being information indicating the number of points in the slice included in the slice inside information.

(16) The information processing device according to any one of (11) to (15),
wherein the decoding target selection unit selects, as a decoding target, the attribute data corresponding to the slice of the geometry selected as the decoding target, on the basis of attribute correspondence information, the attribute correspondence information being information indicating the attribute data corresponding to the slice, and
the decoding unit decodes the attribute data selected by the decoding target selection unit.

(17) The information processing device according to (16),
wherein the attribute correspondence information is information indicating the attribute data using identification information of a bitstream of an attribute, and
the decoding target selection unit uses the identification information of the bitstream of the attribute corresponding to the slice of the geometry selected as the decoding target, the identification information being indicated in the attribute correspondence information, to perform the selection of the attribute data as the decoding target.

(18) The information processing device according to any one of (11) to (17),
wherein the decoding target selection unit acquires the slice as a decoding target from the bitstream of the geometry on the basis of slice address information, the slice address information being information indicating a position of the slice in the geometry data.

(19) The information processing device according to any one of (11) to (18),
wherein the decoding target selection unit performs selection of the slice as a decoding target on the basis of parallelization information, the parallelization information being information on parallelization of decoding processing, and
the decoding unit parallelizes decoding processing for a plurality of the slices selected by the decoding target selection unit on the basis of the parallelization information.

(20) An information processing method including:
selecting, as a decoding target, a slice of geometry data corresponding to a resolution and a region of a geometry as a decoding target from a bitstream of the geometry, on the basis of slice correspondence information, the slice correspondence information being information indicating the slice of the geometry data corresponding to the resolution and the region of the geometry, for a point cloud representing an object having a three-dimensional shape as a set of points; and
decoding the selected slice.

### REFERENCE SIGNS LIST

100 Encoding device
101 Geometry data encoding unit
102 Attribute data encoding unit
111 Structure forming unit
112 Metadata generation unit
113 Encoding unit
200 Decoding device
201 Decoding target selection unit
202 Storage unit
203 Decoding unit
211 Control unit
212 Geometry data decoding unit
213 Attribute data decoding unit
214 Point cloud generation unit
900 Computer

1. An information processing device comprising:
a slice correspondence information generation unit configured to generate slice correspondence information, the slice correspondence information being information indicating a slice of geometry data corresponding to a resolution and a region of a geometry, for a point cloud representing an object having a three-dimensional shape as a set of points; and
an encoding unit configured to encode the geometry data to generate a bitstream of the geometry including the slice correspondence information generated by the slice correspondence information generation unit.

2. The information processing device according to claim 1, wherein the slice correspondence information is information indicating the slice corresponding to the resolution and the region using identification information of the slice.

3. The information processing device according to claim 1,
wherein the slice correspondence information generation unit further generates decoding order information, the decoding order information being information on the decoding order of the slices corresponding to the resolution and the region, and
the encoding unit further includes the decoding order information in the bitstream.

4. The information processing device according to claim 1,
wherein the slice correspondence information generation unit further generates slice inside information, the slice inside information being information on the inside of the slice, and
the encoding unit further includes the slice inside information in the bitstream.

5. The information processing device according to claim 4, wherein the slice inside information includes number-of-points information, the number-of-points information being information indicating the number of points in the slice.

6. The information processing device according to claim 1,
wherein the slice correspondence information generation unit further generates attribute correspondence information, the attribute correspondence information being information indicating attribute data corresponding to the slice, and
the encoding unit further includes the attribute correspondence information in the bitstream.

7. The information processing device according to claim 6, wherein the attribute correspondence information is information indicating the attribute data using identification information of a bitstream of an attribute.

8. The information processing device according to claim 1,
wherein the slice correspondence information generation unit further generates slice address information, the slice address information being information indicating a position of the slice in the geometry data, and
the encoding unit further includes the slice address information in the bitstream.

9. The information processing device according to claim 1,
wherein the slice correspondence information generation unit further generates parallelization information, the parallelization information being information on parallelization of decoding processing, and
the encoding unit further includes the parallelization information in the bitstream.

10. An information processing method comprising:
generating slice correspondence information, the slice correspondence information being information indicating a slice of geometry data corresponding to a resolution and a region of a geometry, for a point cloud representing an object having a three-dimensional shape as a set of points; and
encoding the geometry data to generate a bitstream of the geometry including the generated slice correspondence information.

11. An information processing device comprising:
a decoding target selection unit configured to select, as a decoding target, a slice of geometry data corresponding to a resolution and a region of a geometry as a decoding target from a bitstream of the geometry, on the basis of slice correspondence information, the slice correspondence information being information indicating the slice of the geometry data corresponding to the resolution and the region of the geometry, for a point cloud representing an object having a three-dimensional shape as a set of points; and
a decoding unit configured to decode the slice selected by the decoding target selection unit.

12. The information processing device according to claim 11,
wherein the slice correspondence information is information indicating the slice corresponding to the resolution and the region using identification information of the slice, and
the decoding target selection unit performs the selection of the slice as a decoding target using identification information of the slice corresponding to the resolution and the region as a decoding target, the identification information being indicated in the slice correspondence information.

13. The information processing device according to claim 11,
wherein the decoding target selection unit performs the selection of the slice as a decoding target in a decoding order indicated by decoding order information, the decoding order information being information on the decoding order of the slice corresponding to the resolution and the region.

14. The information processing device according to claim 11, wherein the decoding unit parallelizes decoding processing of the plurality of slices selected by the decoding target selection unit on the basis of slice inside information, the slice inside information being information on the inside of the slice.

15. The information processing device according to claim 14, wherein the decoding unit parallelizes the decoding processing of the plurality of slices selected by the decoding target selection unit on the basis of number-of-points information, the number-of-points information being information indicating the number of points in the slice included in the slice inside information.

16. The information processing device according to claim 11,
wherein the decoding target selection unit selects, as a decoding target, the attribute data corresponding to the slice of the geometry selected as the decoding target, on the basis of attribute correspondence information, the attribute correspondence information being information indicating the attribute data corresponding to the slice, and
the decoding unit decodes the attribute data selected by the decoding target selection unit.

17. The information processing device according to claim 16,
wherein the attribute correspondence information is information indicating the attribute data using identification information of a bitstream of an attribute, and
the decoding target selection unit uses the identification information of the bitstream of the attribute corresponding to the slice of the geometry selected as the decoding target, the identification information being indicated in the attribute correspondence information, to perform the selection of the attribute data as the decoding target.

18. The information processing device according to claim 11, wherein the decoding target selection unit acquires the slice as a decoding target from the bitstream of the geometry on the basis of slice address information, the slice address information being information indicating a position of the slice in the geometry data.

19. The information processing device according to claim 11,
wherein the decoding target selection unit performs selection of the slice as a decoding target on the basis of parallelization information, the parallelization information being information on parallelization of decoding processing, and
the decoding unit parallelizes decoding processing for a plurality of the slices selected by the decoding target selection unit on the basis of the parallelization information.

20. An information processing method comprising:
selecting, as a decoding target, a slice of geometry data corresponding to a resolution and a region of a geometry as a decoding target from a bitstream of the geometry, on the basis of slice correspondence information, the slice correspondence information being information indicating the slice of the geometry data corresponding to the resolution and the region of the geometry, for a point cloud representing an object having a three-dimensional shape as a set of points; and
decoding the selected slice.
